(19) United States
(12) Patent Application Publication
(10) Pub. No.: US 2024/0056965 A1
(43) Pub. Date: Feb. 15, 2024

(54) METHOD AND APPARATUS FOR WAKE-UP RECEIVING IN WIRELESS COMMUNICATION

(71) Applicant: SAMSUNG ELECTRONICS CO., LTD., Suwon-si (KR)

(72) Inventors: Seunghoon CHOI, Suwon-si (KR); Hyunseok RYU, Suwon-si (KR); Hyewon YANG, Suwon-si (KR); Jaewon LEE, Suwon-si (KR); Junyung YI, Suwon-si (KR)

(21) Appl. No.: 18/446,333

(22) Filed: Aug. 8, 2023

(30) Foreign Application Priority Data
Aug. 10, 2022 (KR) 10-2022-0099641
Sep. 27, 2022 (KR) 10-2022-0122853

(51) Int. Cl. H04W 52/02; H04W 76/28

(52) U.S. Cl. CPC H04W 52/0212; H04W 76/28; H04W 88/06

(57) ABSTRACT

The disclosure relates to a 5G or 6G communication system for supporting a higher data transmission rate. A method performed by a User Equipment (UE) in a wireless communication system includes receiving, by a Wake Up Receiver (WUR) of the UE, information on wake-up from a Base Station (BS), triggering activation or inactivation of a main radio of the UE, based on the information on wake-up, and receiving, by the main radio of the UE, a downlink signal from the BS, when the activation of the main radio of the UE is triggered.

### CROSS-REFERENCE TO RELATED APPLICATIONS

This application is based on and claims priority under 35 U.S.C. § 119 to Korean Patent Application No. 10-2022-0099641 filed on Aug. 10, 2022, and Korean Patent Application No. 10-2022-0122853 filed on Sep. 27, 2022, in the Korean Intellectual Property Office, the disclosure of which is incorporated by reference herein in its entirety.

### BACKGROUND

### 1. Field

The disclosure relates to a method and apparatus for wake-up receiving in a wireless communication system.

Specifically, the disclosure relates to a method and apparatus for signal transmission of a terminal having a wake-up receiver to solve an excessive power consumption problem of the terminal and to achieve high energy efficiency in the wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (Bandwidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As described above, with the development of the wireless communication system, a method for signal transmission of a UE having a wake-up receiver is required to solve an excessive power consumption problem of the UE and to achieve high energy efficiency.

### SUMMARY

Based on the aforementioned discussion, the disclosure is to provide a method and apparatus capable of providing seamless communication efficiency of a terminal having a wake-up receiver in a wireless communication system.

According to various embodiments of the disclosure, a method performed by a User Equipment (UE) in a wireless communication system may include receiving, by a Wake Up Receiver (WUR) of the UE, information on wake-up from a Base Station (BS), triggering activation or inactivation of a main radio of the UE, based on the information on wake-up, and receiving, by the main radio of the UE, a downlink signal from the BS, when the activation of the main radio of the UE is triggered.

According to various embodiments of the disclosure, a method performed by a BS in a wireless communication system may include transmitting information on wake-up to a WUR of a UE, receiving a feedback signal related to whether activation of a main radio of the UE is triggered, based on the information on wake-up, and transmitting a downlink signal to the main radio of the UE, when the activation of the main radio of the UE is triggered.

According to various embodiments of the disclosure, a UE in a wireless communication system may include at least one transceiver and at least one processor operatively coupled to the at least one processor. The at least one processor may be configured to receive, by a WUR of the UE, information on wake-up from a BS, trigger activation or inactivation of a main radio of the UE, based on the information on wake-up, and when the activation of the main radio of the UE is triggered, receive, by the main radio of the UE, a downlink signal from the BS.

According to various embodiments of the disclosure, a BS in a wireless communication system may include at least one transceiver and at least one processor operatively coupled to the at least one processor. The at least one processor may be configured to transmit information on wake-up to a WUR of a UE, receive a feedback signal related to whether activation of a main radio of the UE is triggered, based on the information on wake-up, and transmit a downlink signal to the main radio of the UE, when the activation of the main radio of the UE is triggered.

Various embodiments of the disclosure may provide an apparatus and method capable of efficiently providing a service in a wireless communication system.

Advantages acquired in the disclosure are not limited to the aforementioned advantages, and other advantages not mentioned herein may be clearly understood by those skilled in the art to which the disclosure pertains from the following descriptions.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWING

For a more complete understanding of the present disclosure and its advantages, reference is now made to the following description taken in conjunction with the accompanying drawings, in which like reference numerals represent like parts:

FIG. 1 illustrates a basic structure of a time-frequency resource domain in a wireless communication system according to various embodiments of the disclosure;

FIG. 2 illustrates a time domain mapping structure and a beam sweeping operation for a synchronization signal according to various embodiments of the disclosure;

FIG. 3 illustrates a signal flow for performing Random Access (RA) according to various embodiments of the disclosure;

FIG. 4 illustrates a signal flow for reporting User Equipment (UE) information by a UE to a Base Station (BS) according to various embodiments of the disclosure;

FIG. 5 illustrates an example of a state transition of a BS and UE and a state of the UE depending on a state of the BS according to various embodiments of the disclosure;

FIG. 6 illustrates an operational flow of a UE for receiving a wake-up signal according to various embodiments of the disclosure;

FIG. 7 illustrates an operational flow of a BS for transmitting a wake-up signal according to various embodiments of the disclosure;

FIG. 8 illustrates a functional structure of a BS according to various embodiments of the disclosure; and

FIG. 9 illustrates a functional structure of a UE in a wireless communication system according to various embodiments of the disclosure.

### DETAILED DESCRIPTION

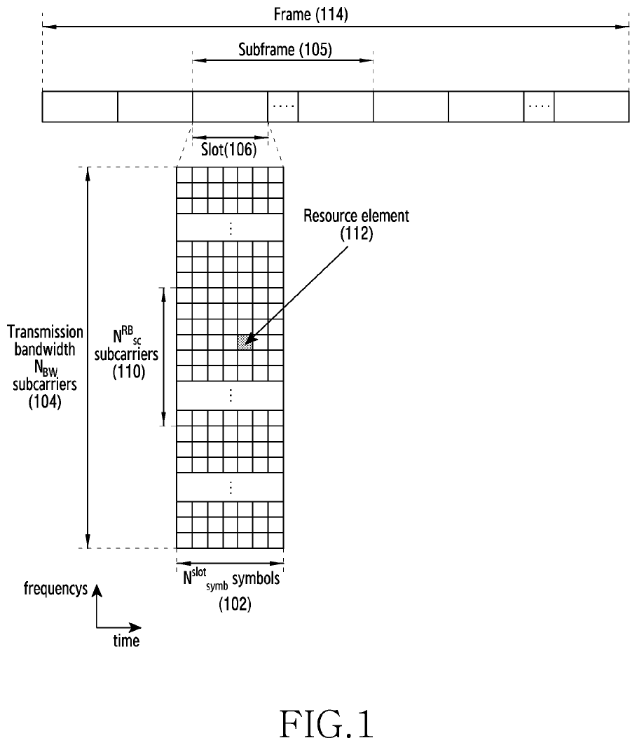

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Terms used in the disclosure are for the purpose of describing particular embodiments only and are not intended to limit other embodiments. A singular expression may include a plural expression unless there is a contextually distinctive difference. All terms (including technical and scientific terms) used herein have the same meaning as commonly understood by those ordinarily skilled in the art disclosed in the disclosure. It will be further understood that terms, such as those defined in commonly used dictionaries, should be interpreted as having a meaning which is consistent with their meaning in the context of the relevant art, and will not be interpreted in an idealized or overly formal sense unless expressly so defined herein. Optionally, the terms defined in the disclosure should not be interpreted to exclude the embodiments of the disclosure.

A hardware-based approach is described for example in the various embodiments of the disclosure described hereinafter. However, since the various embodiments of the disclosure include a technique in which hardware and software are both used, a software-based approach is not excluded in the embodiments of the disclosure.

Embodiments of the disclosure will be described herein below with reference to the accompanying drawings. In addition, in the following description, well-known functions or constructions are not described in detail when they would obscure the disclosure in unnecessary detail. Also, the terms used herein are defined according to the functions of the disclosure. Thus, the terms may vary depending on a user's or operator's intention and usage. Therefore, the terms used herein may be understood based on the descriptions made herein.

Advantages and features of the disclosure and methods of accomplishing the same may be understood more clearly by reference to the following detailed description of the embodiments and the accompanying drawings. However, the disclosure is not limited to embodiments disclosed below, and may be implemented in various forms. Rather, the embodiments are provided to complete the disclosure and to fully convey the concept of the disclosure to one of those ordinarily skilled in the art, and the disclosure will only be defined by the scope of claims. Throughout the specification, like reference numerals denote like components.

In this case, it will be understood that blocks of processing flow diagrams and combinations of the flow diagrams may be performed by computer program instructions. Since these computer program instructions may be loaded into a processor of a general purpose computer, a special purpose computer, or another programmable data processing apparatus, the instructions, which are performed by a processor of a computer or another programmable data processing apparatus, create a means for performing functions described in the block(s) of the flow diagram. The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufacturing items containing an instruction means for performing the functions described in the block(s) of the flow diagram. The computer program instructions may also be loaded into a computer or another programmable data processing apparatus, and thus, instructions for operating the computer or another programmable data processing apparatus by generating a computer-executed process when a series of operations are performed in the computer or another programmable data processing apparatus may provide operations for performing the functions described in the block(s) of the flow diagram.

In addition, each block may represent part of a module, segment, or code which includes one or more executable instructions for executing specified logical function(s). It should also be noted that in some alternative implementations, functions mentioned in blocks may occur not in an orderly manner. For example, two blocks illustrated successively may actually be executed substantially concurrently, or the blocks may sometimes be performed in a reverse order according to corresponding functions.

The term ‘˜unit’ used herein implies a software or hardware component, such as a Field Programmable Gate Array (FPGA) or Application Specific Integrated Circuit (ASIC), which performs certain tasks. However, the ‘˜unit’ is not limited to the software or hardware component. The ‘˜unit’ may be configured to reside on an addressable storage medium and configured to execute one or more processors. Thus, for example, the ‘˜unit’ may include components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the components and ‘˜units’ may be combined into fewer components or ‘˜units’ further separated into additional components and ‘˜units’. In addition thereto, the components and ‘˜units’ may be implemented to reproduce one or more Central Processing Units (CPUs) included in a device or a security multimedia card. In addition, the ‘˜units’ may include one or more processors.

In the following description, well-known functions or constructions are not described in detail when they would obscure the disclosure in unnecessary detail. Also, the terms used herein are defined according to the functions of the disclosure. Hereinafter, an embodiment of the disclosure is described with reference to the accompanying drawings.

In addition, in the following description, terms for identifying an access node, terms referring to network entities, terms referring to messages, terms referring to an interface between network entities, terms referring to various pieces of identification information, or the like are exemplified for convenience of explanation. Therefore, without being limited to the terms used in the disclosure, other terms having equivalent technical meanings may also be used.

In the following description, a physical channel and a signal may be used interchangeably with data or a control signal. For example, although a Physical Downlink Shared Channel (PDSCH) is a term referring to a physical channel through which data is transmitted, the PDSCH may also be used to refer to data. That is, in the disclosure, an expression that ‘a physical channel is transmitted’ may be interpreted equivalent to an expression that ‘data or a signal is transmitted through a physical channel’.

Hereinafter, in the disclosure, higher signaling refers to a method of transferring a signal from a base station to a terminal by using a downlink data channel of a physical layer or from the terminal to the base station by using an uplink data channel of the physical layer. The higher signaling may be understood as Radio Resource Control (RRC) signaling or Media Access Control (MAC) Control Element (CE).

In addition, although the disclosure describes various embodiments by using terms used in some communication standards (e.g., 3rd Generation Partnership Project (3GPP)), this is for exemplary purposes only. Various embodiments of the disclosure may be easily modified and applied to other communication systems. In addition, the term ‘terminal’ may represent not only handphones, smartphones, IoT devices, and sensors but also other wireless communication devices.

Hereinafter, a base station is an entity which performs resource allocation of a terminal, and may be at least one of a gNode B, a gNB, an eNode B, an eNB, a Node B, a Base Station (BS), a radio access unit, a base station controller, and a node on a network. The terminal may include a User Equipment (UE), a Mobile Station (MS), a cellular phone, a smart phone, a computer, or a multimedia system capable of performing a communication function. Of course, the disclosure is not limited to the above example. In addition, although an embodiment of the disclosure is described hereinafter by taking an LTE, LTE-A, or NR based system for example, the embodiment of the disclosure is also applicable to other types of communication systems having a similar technical background and channel format. In addition, the embodiment of the disclosure is also applicable to other communication systems through some modifications within a range not significantly departing from the scope of the disclosure under the decision of those skilled in the art.

Recently, in order to handle explosively growing mobile data traffic, an initial standard for a 5th generation (5G) system or New Radio (NR) access technology, which is a next-generation communication system after Long Term Evolution (LTE) or Evolved Universal Terrestrial Radio Access (E-UTRA) and LTE-Advanced (LTE-A) or E-UTRA evolution, has been complete. While the existing mobile communication systems focused on general voice/data communication, the 5G system is aiming at satisfying various services and requirements, such as enhanced Mobile BroadBand (eMBB) services for improving the existing voice/data communication, Ultra-Reliable and Low Latency Communication (URLLC) services, massive MTC (mMTC) services for supporting communication between a massive number of devices, etc.

In contrast to legacy LTE and LTE-A systems in which a maximum system transmission bandwidth per carrier is limited to 20 megahertz (MHz), the 5G system is mainly aiming at providing data services of ultra-high speeds of several gigabits per second (Gbps) by using a ultrawide bandwidth which is much wider than the transmission bandwidth of the legacy LTE and LTE-A systems. Accordingly, for the 5G system, an ultra-high frequency band from several gigahertz (GHz) up to 100 GHz, in which frequencies having ultrawide bandwidths are easily available, is being considered as a candidate frequency. Additionally, wide-bandwidth frequencies for the 5G system may be obtained by reassigning or allocating frequencies among frequency bands included in a range of several hundreds of MHz to several GHz used by the existing mobile communication systems.

A radio wave in the ultra-high frequency band has a wavelength of several millimeters (mm) and is also referred to as a millimeter wave (mmWave). However, in the ultra-high frequency band, a pathloss of radio waves increases in proportion to a frequency band, and thus, a coverage range of a mobile communication system is reduced.

In order to overcome the reduction in coverage in the ultra-high frequency band, a beamforming technology is applied to increase a radio wave arrival distance by focusing radiation energy of radio waves to a certain target point using a plurality of antennas. In other words, a signal to which the beamforming technology is applied has a relatively narrow beamwidth, and radiation energy is concentrated within the narrow beam width, so that the radio wave arrival distance is increased. The beamforming technology may be applied at both a transmitting end and a receiving end. In addition to increasing the coverage range, the beamforming technology also has an effect of reducing interference in a region other than a beamforming direction. To properly implement the beamforming technology, an accurate transmit/receive beam measurement and feedback method is required. The beamforming technology may be applied to a control channel or a data channel having a one-to-one correspondence between a certain UE and a BS. In addition, in order to increase coverage, the beamforming technology may be applied for control channels and data channels through which the BS transmits, to multiple UEs in a system, common signals such as a synchronization signal, a Physical Broadcast Channel (PBCH), and system information. When the beamforming technology is applied to the common signals, a beam sweeping technique for transmitting a signal by changing a beam direction is additionally applied to allow the common signals to reach a UE located at any position within a cell.

As another requirement for the 5G system, an ultra-low latency service with transmission latency of about lms between the transmitting end and the receiving end is required. As a method for reducing the transmission latency, a frame structure based on a short Transmission Time Interval (TTI) compared to that in LTE and LTE-A needs to be designed. A TTI is a basic time unit for performing scheduling, and a TTI in the legacy LTE and LTE-A systems corresponds to one subframe with a length of lms. For example, as a short TTI for satisfying the requirement for the ultra-low latency service in the 5G systems, TTIs of 0.5 ms, 0.25 ms, 0.125 ms, etc., which are shorter than the TTI in the legacy LTE and LTE-A systems may be supported.

FIG. 1 illustrates a basic structure of a time-frequency resource domain in a wireless communication system according to various embodiments of the disclosure. That is, FIG. 1 is a diagram showing the basic structure of a time-frequency resource domain which is a radio resource region for transmitting data or a control channel of a 5G system.

Referring to FIG. 1, a horizontal axis represents a time domain, and a vertical axis represents a frequency domain. A minimum transmission unit in the time domain of the wireless communication system is an Orthogonal Frequency Division Multiplexing (OFDM) symbol. N_{symb}^{slot} symbols 102 may be aggregated to constitute one slot 106, and Nₛₗₒₜ^{subframe} slots may be aggregated to constitute one subframe 105. The subframe may have a length of 1.0 ms, and 10 subframes may be aggregated to constitute a 10 ms frame 114. A minimum transmission unit in the frequency domain is a subcarrier. A bandwidth of an overall system transmission band may consist of a total of NBW subcarriers 104.

A basic resource unit in the time-frequency domain is a Resource Element (RE) 112 which may be represented by an OFDM symbol index and a subcarrier index. A Resource Block (RB) may be defined as N_{sc}^{RB} consecutive sub-carriers 110 in the frequency domain. In the 5G system, N_{sc}^{RB}=12, and a data rate may increase in proportion to the number of RBs scheduled to a UE.

In the wireless communication system, a BS may map data in units of an RB and generally perform scheduling for a certain UE in units of an RB constituting one slot. In other words, in the 5G system, a basic time unit for scheduling may be a slot, and a basic frequency unit for scheduling may be an RB.

The number N_{symb}^{slot} of OFDM symbols is determined based on a length of a Cyclic Prefix (CP) added to each symbol to prevent inter-symbol interference, and for example, N_{sc}^{RB}=14 when a normal CP is applied, and N_{sc}^{RB}=12 when an extended CP is applied. The extended CP may be applied to a system having a relatively long radio wave transmission distance compared to that for the normal CP, thereby maintaining orthogonality between symbols. For the normal CP, a ratio of a CP length to a symbol length may be maintained at a constant value to keep an overhead due to the CP constant regardless of a subcarrier spacing. In other words, as a subcarrier spacing becomes narrower, a symbol length may increase, and thus, a CP length may increase. On the other hand, as a subcarrier spacing becomes wider, a symbol length may decrease, and thus, a CP length may decrease. A symbol length and a CP length may be inversely proportional to a subcarrier spacing.

In the wireless communication system, in order to satisfy various services and requirements, various frame structures may be supported by adjusting a subcarrier spacing. For example, in terms of an operating frequency band, a wider subcarrier spacing is more advantageous for recovery from phase noise in a high frequency band. In terms of a transmission time, when a subcarrier spacing becomes wider, a symbol length in the time domain is shortened, which leads to a shorter slot, and thus, the wider subcarrier spacing is more advantageous for supporting ultra-low latency services such as URLLC. In terms of a cell size, a larger cell may be supported as a CP length becomes larger, and thus, as a subcarrier becomes narrower, a relatively larger cell may be supported. A cell is a concept indicating an area covered by one BS in mobile communication.

The subcarrier spacing, the CP length, or the like is essential information for OFDM transmission and reception, and the BS and the UE need to recognize such information as a common value to enable seamless transmission and reception.

Table 1 shows a relationship among a subcarrier spacing configuration μ, a subcarrier spacing Δf, and a CP length supported by the 5G system.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2 shows the number N_{symb}^{slot} of symbols per slot, the number Nₛₗₒₜ^{frame,μ} of slots per frame, and the number Nₛₗₒₜ^{frame,μ} of slots per subframe for each subcarrier spacing configuration μ in case of a normal CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 shows the number N_{symb}^{slot} of symbols per slot, the number Nₛₗₒₜ^{frame,μ} of slots per frame, and the number Nₛₗₒₜ^{frame,μ} of slots per subframe for each subcarrier spacing configuration μ in case of an extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

At an early stage of introduction of the 5G system, at least coexistence or dual mode operation with a legacy LTE/LTE-A system is expected. As a result, the legacy LTE/LTE-A system may provide a stable system operation to the UE, and the 5G system may provide enhanced services to the UE. Therefore, a frame structure of the 5G system needs to include at least a frame structure or an essential parameter set (subcarrier spacing=15 kHz) of the legacy LTE/LTE-A system.

For example, comparing a frame structure with a subcarrier spacing configuration μ=0 (hereinafter, a frame structure A) and a frame structure with a subcarrier spacing configuration μ=1 (hereinafter, a frame structure B), the subcarrier spacing and the RB size of the frame structure B are two times larger than those of the frame structure A, whereas a slot length and a symbol length of the frame structure B are two times smaller than those of the frame structure A. In case of the frame structure B, 2 slots may constitute one subframe, and 20 subframes may constitute one frame.

The frame structures of the 5G system is generalized such that essential parameter sets, i.e., a subcarrier spacing, a CP length, a slot length, or the like., have a relationship of integer multiples for each frame structure, providing high scalability. A subframe having a fixed length of lms may be defined to indicate a reference time unit regardless of the frame structure.

The frame structures may be applied to various scenarios. In terms of a cell size, since a larger cell may be supported as a CP length becomes larger, the frame structure A may support a relatively large cell compared to the frame structures B. In terms of an operating frequency band, since a wider subcarrier spacing is more advantageous for recovery from phase noise in a high frequency band, the frame structure B may support a relatively high operating frequency compared to the frame structures A. In terms of a service, since a smaller length of a slot as a basic scheduling unit is more advantageous for supporting ultra-low latency services such as URLLC, the frame structure B may be more suitable for a URLLC service than the frame structure A.

In the following description of the disclosure, Uplink (UL) refers to a radio link through which a UE transmits data or a control signal to a BS, and Downlink (DL) refers to a radio link through which the BS transmits data or a control signal to the UE.

During an initial access procedure in which the UE accesses a system for the first time, the UE may perform cell search to align DL time and frequency synchronization and obtain a cell Identity (ID) from a synchronization signal transmitted by the BS. The UE may use the obtained cell ID to receive a PBCH, and obtain a Master Information Block (MIB) which is essential system information from the PBCH. In addition, the UE may receive system information (e.g., a System Information Block (SIB)) transmitted by the BS to obtain cell-common transmission/reception related control information. The cell-common transmission/reception related control information may include random access related control information, paging related control information, common control information regarding various physical channels, or the like.

A synchronization signal is used as a reference for the cell search, and a subcarrier spacing may be applied to the synchronization signal for each frequency band and to be suitable for a channel environment, e.g., phase noise. In case of a data channel or a control channel, different subcarrier spacings may be applied depending on a service type in order to support various services as described above.

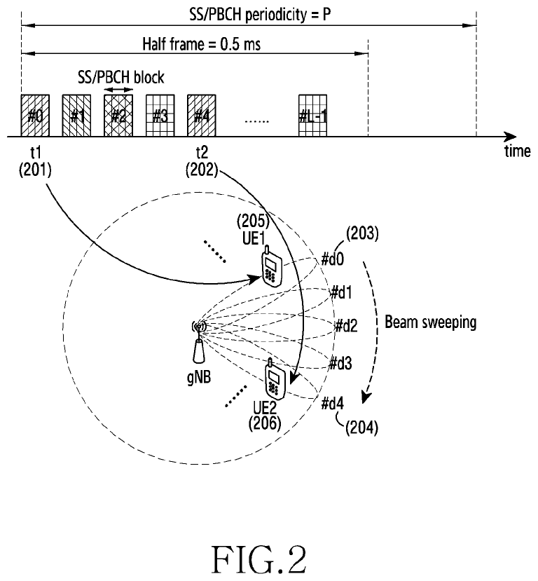

FIG. 2 illustrates a time domain mapping structure and a beam sweeping operation for a synchronization signal according to various embodiments of the disclosure.

Hereinafter, the following components may be defined in advance to describe the disclosure.
Primary Synchronization Signal (PSS): It is a signal used as a reference for DL time/frequency synchronization, and may provide some parts of information on a cell ID.
Secondary Synchronization Signal (SSS): It is used as a reference for DL time/frequency synchronization, and may provide the remaining parts of the cell ID. The SSS may also serve as a reference signal for demodulation of a PBCH.
Physical Broadcast Channel (PBCH): It may provide a Master Information Block (MIB) which is essential system information necessary for a UE to transmit and receive a data channel and a control channel. The essential system information may include search space related control information indicating radio resource mapping information of a control channel, scheduling control information of a separate data channel for transmitting system information, and information such as a System Frame Number (SEN) as an index in a frame level which becomes a timing reference.
SS/PBCH Block (or SSB): The SS/PBCH block may consist of N OFDM symbols and may include a combination of the PSS, the SSS, and the PBCH. In case of a system using a beam sweeping technique, the SS/PBCH block may be a smallest unit for applying beam sweeping. In the 5G system, N=4. A gNB may transmit a maximum of L SS/PBCH blocks, and the L SS/PBCH blocks may be mapped within a half frame (0.5 ms). The L SS/PBCH blocks may be periodically repeated with specific units of a periodicity P. The gNB may inform the UE of the periodicity P through signaling. If there is no separate signaling for the periodicity P, the UE may apply a predetermined default value.

An example in which beam sweeping is applied in units of an SS/PBCH block over time is illustrated in FIG. 2. Referring to FIG. 2, a UE1 205 may receive an SS/PBCH block by using a beam radiated in a direction #d0 203 due to beamforming applied to an SS/PBCH block #0 at a timing t1 201. A UE2 206 may receive an SS/PBCH block by using a beam radiated in a direction #d4 204 due to beamforming applied to an SS/PBCH block #4 at a timing t2 202. The UE may obtain an optimal synchronization signal via a beam radiated from a gNB in a direction toward a location of the UE. For example, it may be difficult for the UE1 205 to obtain time/frequency synchronization and essential system information from an SS/PBCH block via the beam radiated in the direction #d4 204 which is far away from the UE1.

In addition to the initial access procedure, the UE may receive an SS/PBCH block to determine whether radio link quality of a current cell is maintained above a certain threshold level. Furthermore, in a procedure for performing handover of the UE from the current cell to a neighboring cell, the UE may receive an SS/PBCH block from a neighboring cell in order to determine radio link quality of the neighboring cell and obtain time/frequency synchronization of the neighboring cell.

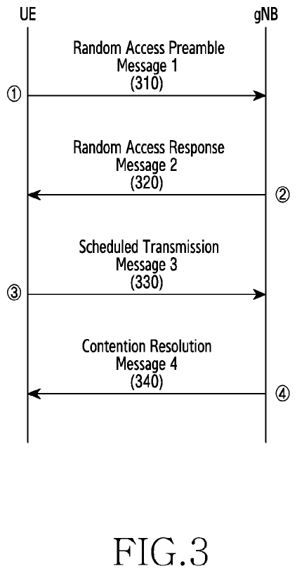

After the UE obtains MIB and system information from the gNB through the initial access procedure, the UE may perform a random access procedure to switch a link with the gNB to a connected state (or RRC CONNECTED state). Upon completion of the random access procedure, the UE transitions to a connected state, and one-to-one communication is enabled between the gNB and the UE. Hereinafter, the random access procedure will be described in detail with reference to FIG. 3.

FIG. 3 illustrates a signal flow for performing Random Access (RA) according to various embodiments of the disclosure.

Referring to FIG. 3, in step 310, a UE may transmit a random access preamble to a gNB. In a random access procedure, the random access preamble, which is a first message transmitted by the UE, may be referred to as a message 1. The gNB may measure a transmission latency value between the UE and the gNB from the random access preamble and align UL synchronization. In this case, the UE may randomly select which random access preamble will be used from a set of random access preambles given by system information in advance. In addition, initial transmission power for the random access preamble may be determined according to a pathloss between the gNB and the UE, which is measured by the UE. Also, the UE may transmit the random access preamble by determining a direction of a transmit beam for the random access preamble from a synchronization signal received from the gNB.

In step 320, the gNB may transmit a UL transmission timing control command to the UE, based on the transmission latency value measured from the random access preamble received in the step 310. The gNB may also transmit, to the UE, a UL resource to be used by the UE and a power control command as scheduling information. Control information regarding a UL transmit beam of the UE may be included in the scheduling information.

If the UE does not successfully receive, from the gNB, a Random Access Response (RAR) (or message 2) which is scheduling information for a message 3 within a certain time period in the step 320, the UE may perform the step 310 again. If the UE performs the step 310 again, the UE may transmit the random access preamble with transmission power increased by a certain step (e.g., power ramping), thereby increasing a probability that the gNB receives the random access preamble.

In step 330, the UE may transmit UL data (message 3) including a UE ID of the UE to the gNB through a UE resource allocated in the step 320. The UE may transmit the UL data including the UE ID to the gNB through a UL data channel (e.g., a Physical UL Shared Channel (PUSCH)). A transmission timing of the UL data channel for transmitting the message 3 may be controlled according to the timing control command received from the gNB in the step 320. Transmission power for the UL data channel for transmitting the message 3 may be determined by considering the power control command received from the gNB in the step 320 and a power ramping value of the random access preamble. The UL data channel for transmitting the message 3 may mean a first UL data signal transmitted by the UE to the gNB after the UE transmits the random access preamble.

In step 340, when the gNB determines that the UE has performed the random access procedure without colliding with another UE, the gNB may transmit data (message 4) including an ID of the UE which has transmitted the UL data in the step 330 to the UE. Upon receiving a signal transmitted by the gNB in the step 340, the UE may determine that the random access procedure is successful. The UE may transmit, to the gNB, Hybrid Automatic repeat Request Acknowledgement (HARQ-ACK) information indicating whether the message 4 has been successfully received through a UL control channel (e.g., a Physical UL Control Channel (PUCCH)).

If the data transmitted by the UE in the step 330 collides with data transmitted by another UE and thus the gNB fails to receive a data signal from the UE, the gNB may no longer transmit data to the UE. If the UE fails to receive the data transmitted by the gNB in the step 340 within a certain time period, the UE may determine that the random access procedure has failed and restart the random access procedure from the step 310.

Upon successful completion of the random access procedure, the UE may transition to a connected state, and one-to-one communication between the gNB and UE is enabled. The gNB may receive UE capability information from the UE in the connected state and adjust scheduling in reference to the UE capability information of the corresponding UE. The UE may inform, via the UE capability information, the gNB of whether the UE itself supports a certain functionality, a maximum allowable value of the functionality supported by the UE, or the like. Accordingly, the UE capability information reported by each UE to the gNB may have a different value for each UE.

As an example, the UE may report, to the gNB, UE capability information including at least one piece of the following control information as the UE capability information.
Control information related to a frequency band supported by the UE
Control information related to a channel bandwidth supported by the UE
Control information related to a highest modulation scheme supported by the UE
Control Information related to a maximum number of beams supported by the UE
Control information related to a maximum number of layers supported by the UE
Control information related to Channel State Information (CSI) reporting supported by the UE
Control information regarding whether the UE supports frequency hopping
Control information related to a bandwidth when CA is supported
Control information regarding whether cross-carrier scheduling is supported when CA is supported

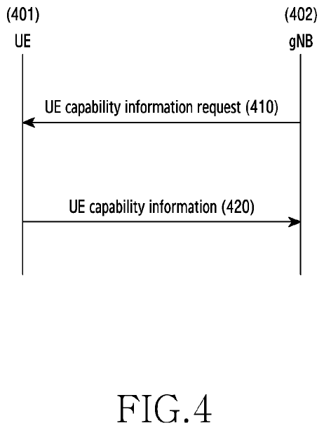

FIG. 4 illustrates a signal flow for reporting UE capability information by a UE to a gNB according to various embodiments of the disclosure.

Referring to FIG. 4, in step 410, a gNB 402 may transmit a UE capability information request message to a UE 401. In response to a request for UE capability information from the gNB, in step 420, the UE transmits the UE capability information to the gNB. According to an embodiment, the UE may transmit the UE capability information to the gNB, irrespective of the UE capability information request of the gNB.

Based on the process of transmitting and receiving the UE capability information, a UE coupled to the gNB, i.e., a UE in an RRC CONNECTED state, may communicate with the gNB in a one-to-one manner. On the contrary, a UE not coupled to the gNB may be in an RRC IDLE state, and the UE in the RRC IDLE state may perform the following operation.
Perform a UE-specific Discontinuous Reception (DRX) cycle configured by a higher layer
Receive a paging message from a core network
Obtain system information
Perform neighbor cell measurement and cell reselection

A UE in a new state called RRC INACTIVE is defined in the 5G system to reduce energy and time consumed in initial access. The RRC INACTIVE UE may perform the following operation, in addition to operations performed by the RRC IDLE UE.
Store Access Stratum (AS) information required in cell access
Operate a UE-specific DRX cycle configured by an RRC layer
Configure a Radio Access Network (RAN)-based Notification Area (RNA) which may be utilized when a handover is performed by an RRC layer, and perform a cyclical update
Monitor a RAN-based paging message transmitted through an Inactive-Radio Network Temporary Identifier (I-RNTI)

Hereinafter, a scheduling method in which a BS transmits DL data to a UE or instructs UL data transmission of the UE.

Downlink Control Information (DCI) is control information transmitted by the BS to the UE through a downlink. The DCI may include DL data scheduling information or UL data scheduling information for a certain UE. In general, the BS may perform channel-coding on the DCI independently for each UE and then transmit it to each UE through a downlink physical control channel, i.e., a Physical Downlink Control Channel (PDCCH).

For a UE to be scheduled, the BS may operate by applying a predefined DCI format according to purposes such as whether it is scheduling information for DL data (downlink assignment), whether it is scheduling information for UL data (UL grant), whether it is DCI for power control, or the like.

The BS may transmit DL data to the UE through a Physical Downlink Shared Channel (PDSCH) which is a physical channel for DL data transmission. The BS may inform the UE of scheduling information, such as a specific mapping location in the time-frequency domain for the PDSCH, a modulation scheme, HARQ related control information, power control information, or the like by using DCI related to DL data scheduling information among a plurality of pieces of DCI transmitted through the PDCCH.

The UE may transmit UL data to the BS through a PUSCH which is a physical channel for UL data transmission. The BS may inform the UE of scheduling information, such as a specific mapping location in the time-frequency domain for the PUSCH, a modulation scheme, HARQ-related control information, power control information, or the like by using DCI related to UL data scheduling information among the plurality of pieces of DCI transmitted through the PDCCH.

Time-frequency resources to which the PDCCH is mapped may be referred to as a Control Resource Set (CORESET). The CORESET may be configured in all or some frequency resources within a bandwidth supported by the UE in the frequency domain. The CORESET may be configured in one or a plurality of OFDM symbols, which may be defined as a CORESET duration. The BS may configure the UE with one or a plurality of CORESETs through higher layer signaling (e.g., System Information (SI), Master Information Block (MIB), or Radio Resource Control (RRC) signaling). Configuring the UE with the CORESET means providing the UE with information such as a CORESET identity, a frequency location of the CORESET, a symbol length of the CORESET, or the like. A plurality of piece of information provided by the BS to the UE to configure a CORESET may include at least some of the following pieces of information included in Table 4 below.

```
TABLE 4
ControlResourceSet ::= SEQUENCE {
    controlResourceSetId ControlResourceSetId,
    frequencyDomainResources BIT STRING (SIZE (45)),
  duration INTEGER (1..maxCoReSetDuration),
    cce-REG-MappingType CHOICE {
      interleaved SEQUENCE {
          reg-BundleSize ENUMERATED {n2, n3, n6},
        interleaverSize ENUMERATED {n2, n3, n6},
        shiftIndex
INTEGER (0..maxNrofPhysicalResourceBlocks-1) OPTIONAL -- Need
S
      },
      nonInterleaved NULL
    },
    precoderGranularity ENUMERATED {sameAsREG-bundle,
allContiguousRBs},
  tci-StatesPDCCH-ToAddList SEQUENCE(SIZE (1..maxNrofTCI-
StatesPDCCH)) OF TCI-StateId OPTIONAL, -- Cond
NotSIB1-initialBWP
    tci-StatesPDCCH-ToReleaseList SEQUENCE(SIZE (1..maxNrofTCI-
StatesPDCCH)) OF TCI-StateId OPTIONAL, -- Cond
NotSIB1-initialBWP
    tci-PresentInDCI ENUMERATED {enabled}
OPTIONAL, -- Need S
    pdcch-DMRS-ScramblingID INTEGER (0..65535)
OPTIONAL, -- Need S
}
```

A CORESET may consist of N_{RB}^{CORESET} in the frequency domain and N_{RB}^{CORESET}∈{1,2,3} symbols in the time domain. An NR PDCCH may consist of one or a plurality of Control Channel Elements (CCEs). One CCE may consist of 6 Resource Element Groups (REGs), and the REG may be defined as 1 RB in one OFDM symbol. In one CORESET, the REGs may be indexed in a time-first manner starting at an REG index 0 for a first OFDM symbol and a lowest-numbered RB of the CORESET.

An interleaved type and a non-interleaved type may be supported as a transmission method for the PDCCH. The BS may configure, through higher layer signaling, the UE with whether a transmission type is interleaved or non-interleaved for each CORESET. Interleaving may be performed in units of REG bundles. The REG bundle may be defined as a set of one or a plurality of REGs. The UE may determine a CCE-to-REG mapping type for a corresponding CORESET in a manner as shown in Table 5 below, based on whether the transmission type is interleaved or non-interleaved as configured by the BS.

TABLE 5
The CCE-to-REG mapping for a control-resource set can be interleaved or non-
interleaved and is described by REG bundles:

| | |
|---|---|
| - | REG bundle i is defined as REGs {iL,iL+1,...,iL+L−1} where L is the REG |
| | bundle size, i = 0,1, ... , N_{REG}^{CORESET}/L − 1, and N_{REG}^{CORESET} = N_{RB}^{CORESET}N_{symb}^{CORESET} |
| | is the number of REGs in the CORESET |
| - | CCE j consists of REG bundles {f(6j/L),f(6j/L+1),...,f(6j/L+6/L−1)} where |
| | f(·) is an interleaver |

```
For non-interleaved CCE-to-REG mapping, L = 6 and f(x) = x.
For interleaved CCE-to-REG mapping, L ∈ {2,6}for N_{symb}^{CORESET} = 1 and L ∈
{N_{symb}^{CORESET}, 6} for N_{symb}^{CORESET} ∈ {2,3}. The interleaver is defined by
    f(x) = (rC + c + n_{shift}) mod (N_{REG}^{CORESET}/L)
          x = cR + r
        r = 0,1, ... , R − 1
        c = 0,1, ... , C − 1
      C = N_{REG}^{CORESET}/(LR)
where R ∈ (2,3,6}.
```

The BS may inform, through signaling, the UE of configuration information such as symbols to which the PDCCH is mapped in a slot, a transmission periodicity, or the like.

A search space of the PDCCH is described as follows. The number of CCEs required to transmit the PDCCH may be 1, 2, 4, 8, or 16 depending on an Aggregation Level (AL), and a different number of CCEs may be used for link adaptation of a DL control channel. For example, when AL=L, one DL control channel may be transmitted using L CCEs. The UE may perform blind decoding for detecting a signal in a state where information regarding a DL control channel is unknown, and a search space representing a set of CCEs may be defined for the blind decoding. The search space is a set of DL control channel candidates constructed of CCEs for which the UE attempts to perform decoding at a given AL. Since there are several ALs for creating one aggregation with 1, 2, 4, 8, and 16 CCEs, the UE may have a plurality of search spaces. A search space set may be defined as a set of search spaces at all configured ALs.

The search space may be classified into a Common Search Space (CSS) and a UE-Specific search Space (USS). A certain group of UEs or all UEs may monitor a CSS of a PDCCH in order to receive cell-common control information such as dynamic scheduling of system information (or a System Information Block (SIB)) or paging messages. For example, the UE may receive scheduling allocation information of a PDSCH for receiving the system information, by monitoring the CSS of the PDCCH. The CSS may be defined as a predetermined set of CCEs since a certain group of UEs or all UEs need to receive the PDCCH. The UE may receive scheduling allocation information for UE-specific PDSCH or PUSCH, by monitoring a USS of the PDCCH. The USS may be defined in a UE-specific manner by using an Identity (ID) of the UE and a function of various system parameters.

The BS may configure the UE with configuration information for a search space of the PDCCH through higher layer signaling (e.g., SIB, MIB, RRC signaling). For example, the BS may configure the UE with the number of PDCCH candidates at each AL L, a monitoring periodicity for the search space, monitoring occasions in symbols within slots for the search space, a search space type (the CSS or the USS), a combination of DCI format and RNTI to be monitored in the search space, and an index of a CORESET in which the search space is to be monitored. For example, parameters for the search space for the PDCCH may include a plurality of pieces of information as shown in Table 6 below.

TABLE 6

| | |
|---|---|
| SearchSpace ::= | SEQUENCE { |
| searchSpaceId | SearchSpaceId, |
| controlResourceSetId | ControlResourceSetId |

OPTIONAL, -- Cond SetupOnly

| | |
|---|---|
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

}
OPTIONAL, -- Cond Setup

| | |
|---|---|
| duration | INTEGER (2..2559) |

OPTIONAL, -- Need R

| | |
|---|---|
| monitoringSymbolsWithinSlot | BIT STRING (SIZE (14)) |

OPTIONAL, -- Cond Setup

| | |
|---|---|
| nrofCandidates | SEQUENCE { |
| aggregationLevel1 | ENUMERATED {n0, n1, n2, |

n3, n4, n5, n6, n8},

| | |
|---|---|
| aggregationLevel2 | ENUMERATED {n0, n1, n2, |

n3, n4, n5, n6, n8},

| | |
|---|---|
| aggregationLevel4 | ENUMERATED {n0, n1, n2, |

n3, n4, n5, n6, n8],

| | |
|---|---|
| aggregationLevel8 | ENUMERATED {n0, n1, n2, |

n3, n4, n5, n6, n8},

| | |
|---|---|
| aggregationLevel16 | ENUMERATED {n0, n1, n2, |

n3, n4, n5, n6, n8)
}
OPTIONAL, -- Cond Setup

| | |
|---|---|
| searchSpaceType | CHOICE { |
| common | SEQUENCE { |
| dci-Format0-0-AndFormat1-0 | SEQUENCE { |

```
        ...
      }
OPTIONAL, -- Need R
```

| | |
|---|---|
| dci-Format2-0 | SEQUENCE { |
| nrofCandidates-SFI | SEQUENCE { |
| aggregationLevel1 | ENUMERATED {n1, |

n2} OPTIONAL, -- Need R

| | |
|---|---|
| aggregationLevel2 | ENUMERATED {n1, |

n2} OPTIONAL, -- Need R

| | |
|---|---|
| aggregationLevel4 | ENUMERATED {n1, |

n2} OPTIONAL, -- Need R

| | |
|---|---|
| aggregationLevel8 | ENUMERATED {n1, |

n2} OPTIONAL, -- Need R

| | |
|---|---|
| aggregationLevel16 | ENUMERATED {n1, |

```
n2} OPTIONAL -- Need R
        },
        ...
      }
OPTIONAL, -- Need R
```

| | |
|---|---|
| dci-Format2-1 | SEQUENCE { |

```
        ...
      }
OPTIONAL, -- Need R
```

| | |
|---|---|
| dci-Format2-2 | SEQUENCE { |

```
        ...
      }
OPTIONAL, -- Need R
```

| | |
|---|---|
| dci-Format2-3 | SEQUENCE { |
| dummy1 | ENUMERATED (sl1, sl2, |

sl4, sl5, sl8, sl10, sl16, sl20} OPTIONAL, -- Cond Setup

| | |
|---|---|
| dummy2 | ENUMERATED {n1, n2}, |

```
        ...
      }
OPTIONAL -- Need R
    },
```

| | |
|---|---|
| ue-Specific | SEQUENCE { |
| dci-Formats | ENUMERATED {formats0- |

```
0-And-1-0, formats0-1-And-1-1},
      ...,
| }
  }
OPTIONAL -- Cond Setup2
}
```

According to the configuration information, the BS may configure the UE with one or a plurality of search space sets. According to an embodiment, the BS may configure the UE with a search space set 1 and a search space set 2. For the search space set 1, the UE may be configured to monitor, in a CSS, a DCI format A scrambled with X-RNTI. For the search space set 2, the UE may be configured to monitor, in a USS, a DCI format B scrambled with Y-RNTI.

According to the configuration information, one or a plurality of search space sets may exist in the CSS or USS. For example, a search space set #1 and a search space set #2 may be configured as the CSS, and a search space set #3 and a search space set #4 may be configured as the USS.

The UE may monitor, in the CSS, the following combinations of DCI formats and RNTIs. Of course, various embodiments of the disclosure are not limited to the following example.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

The UE may monitor, in the USS, the following combinations of DCI formats and RNTIs. Of course, various embodiments of the disclosure are not limited to the following example.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The RNTIs may comply with the following definitions and uses. Of course, various embodiments of the disclosure are not limited to the following example.
Cell RNTI (C-RNTI): used for scheduling a UE-specific PDSCH or PUSCH
Temporary Cell RNTI (TC-RNTI): used for scheduling a UE-specific PDSCH
Configured Scheduling RNTI (CS-RNTI): used for scheduling a semi-statically configured UE-specific PDSCH
Random Access RNTI (RA-RANTI): used for scheduling a PDSCH in a random access procedure
Paging RNTI (P-RNTI): used for scheduling a PDSCH on which paging information is transmitted
System Information RNTI (SI-RNTI): used for scheduling a PDSCH on which system information is transmitted
Interruption RNTI (INT-RNTI): used for notifying whether to puncture a PDSCH
Transmit Power Control for PUSCH RNTI (TPC-PUSCH-RNTI): used for indicating a power control command for a PUSCH
Transmit Power Control for PUCCH RNTI (TPC-PUCCH-RNTI): used for indicating a power control command for a PUCCH
Transmit Power Control for Sounding Reference Signal RNTI (TPC-SRS-RNTI): used for indicating a power control command for SRS

The DCI formats specified above may be defined as shown in Table 7 below.

TABLE 7

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

A search space at an aggregation level L in a CORESET p and a search space set s may be expressed by Equation (1) below:

$$L \cdot \{ ( {Y}_{p , {n}_{s , f}^{μ}} + ⌊ \frac{{m}_{s , {n}_{CI}} \cdot {N}_{C C E , p}}{L \cdot {M}_{p , s , max}^{( L )}} ⌋ + {n}_{CI} ) mod ⌊ {N}_{C C E , p} / L ⌋ \} + i \qquad [ Equation 1 ]$$

L: aggregation level
nCI: carrier index
NCCE,p: total number of CCEs in CORESET p
nμts,f: slot index
M(L)p,s,max: number of PDCCH candidates at aggregation level L
msnCI=0, . . . , M(L)p,s,max −1: indexes of PDCCH candidates at aggregation level L
i=0, . . . , L−1

$${Y}_{p , {n}_{s , f}^{μ}} = ( {A}_{p} \cdot {Y}_{p , {n}_{s , f}^{μ} - 1} ) mod D , {Y}_{p , - 1} = {n}_{R N T I} \neq 0 , {A}_{0} = 39827 , {A}_{1} = 39 \; 829 , {A}_{2} = 39839 , D = 65537$$

nRNTI : UE ID

In case of the CSS, the value

$${Y}_{p , {n}_{s , f}^{μ}}$$

may repsond to 0.

In case of the USS, the value may

$${Y}_{p , {n}_{s , f}^{μ}}$$

may repsond to a value which varies according to a UE ID (C-RNTI or ID configured by BS for UE) and a time index.

As described above, in order to achieve data services at ultra-high speeds of several Gbps for the 5G system, signal transmission and reception of ultrawide bandwidths corresponding to several tens to several hundreds of MHz or several GHz may be supported. The signal transmission and reception of the ultrawide bandwidths may be supported through a single Component Carrier (CC) or a Carrier Aggregation (CA) technology which combines multiple CCs. In a case where a mobile communication operator fails to ensure a high bandwidth frequency enough to provide ultra-high-speed data services with the single CC, the CA technology may combine individual component carriers having relatively small bandwidths to increase a total frequency bandwidth, thereby consequently enabling ultra-high-speed data services.

The 5G system is designed and developed for all various usage cases. In addition to waiting time, reliability, and availability, energy efficiency of the UE is also very importance for 5G. At present, a 5G UE needs to be charged on a weekly or daily basis depending on individual usage time, and generally consumes tens of mW in the RRC_IDLE/RRC_INACTIVE state and hundreds of mW in the RRC_CONNECTED state. A design for extending a battery lifespan may be essential for improving energy efficiency as well as a better user experience. The energy efficiency may be more important for a UE without a continuous energy source (e.g. a UE using small rechargeable and single coin cell batteries). In the 5G usage cases, a sensor and an actuator are widely deployed for monitoring, measuring, charging, or the like. A battery is generally non-rechargeable, and may last for at least several years. In addition, wearables may include a smart watch, a ring, an eHealth-related device, a medical monitoring device, or the like, and in general, it is difficult to last up to 1 to 2 weeks depending on usage time.

As an example of a commercial 5G UE, power consumption of the 5G UE depends on a determined length (e.g., a paging cycle) of wake-up durations. An extended Discontinuous Reception (eDRX) cycle having a great value may be used to satisfy a battery lifespan requirement. However, the eDRX scheme maintains the battery lifespan to be long based on high waiting time, and thus is not suitable for a service with low waiting time. For instance, in an example of using fire detection and extinguishment, it may be necessary to close a fire shutter and turn on a sprinkler by means of the actuator within 1 to 2 seconds from a timing at which the fire is detected. Since the waiting time may be important in this case, a long eDRX cycle as in the conventional case is not suitable since it does not meet a latency requirement.

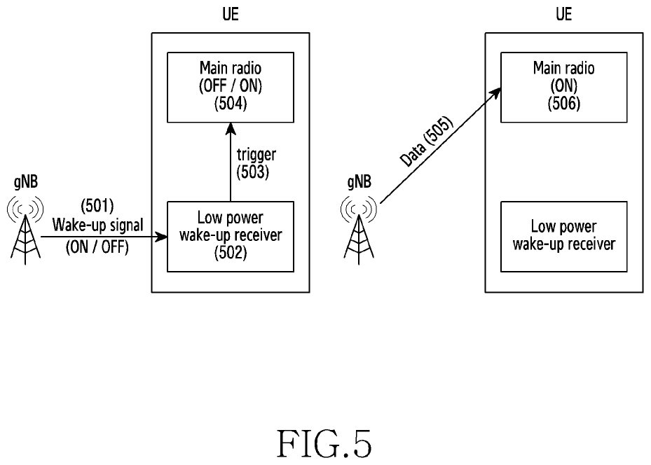

FIG. 5 illustrates an example of a state transition of a BS and UE and a state of the UE depending on a state of the BS according to various embodiments of the disclosure. Specifically, FIG. 5 illustrates the state transition of the BS and UE to solve the aforementioned problem.

At present, a commercial 5G UE may need to wake up periodically once for each eDRX cycle, which may dominate power consumption of a duration in which signaling or data traffic does not exist. If the UE is able to wake up only when the UE is triggered such as paging, power consumption may be significantly reduced. The significant reduction of the power consumption may be achieved in such a manner that a main radio (e.g., the existing NR radio) is triggered by using a Wake-Up Signal (WUS) as shown in FIG. 5 and the main radio is turned on only when data transmission and reception are required by using a Wake Up Receiver (WUR) which is a separate receiver capable of monitoring the WUS with ultra-low power.

According to an embodiment, in step 501, the BS may transmit to the UE a WUS corresponding to ON or OFF.

In step 502, the UE may receive the WUS by using the WUR.

In step 503, the UE may trigger the main radio in an OFF or ON state, based on information indicating that a received signal corresponds to ON or OFF.

In step 504, the UE may configure the main radio to a wake-up or power-off state. According to an embodiment, the main radio may be configured to a deep-sleep state, rather than a complete OFF state.

According to an embodiment, if the WUS transmitted by the BS in step 501 upon occurring data traffic to be transmitted from the BS to the UE (see 505) is a signal corresponding to ON, the main radio may be turned ON, and the UE may receive the data transmitted by the BS through the main radio, rather than the WUR.

According to an embodiment, power consumed to monitor the WUS depends on a WUS design and a hardware module of a WUR used for signal detection and processing, and thus a benefit may be maximized for an IoT usage case (such as an industrial sensor, a controller) and a form factor device which is small in size and sensitive to power, including wearables.

According to an embodiment, a UE including the WUR may report to the BS that the UE is capable of waking up the main radio by using the WUR, or may report capability information indicating that the UE includes the WUR to the BS.

According to an embodiment, the UE may also report to the BS the capability information for the WUR through a UE capability information report procedure of FIG. 4.

According to an embodiment, the UE may report the capability information for the WUR to the BS through at least one step of a random access preamble or an uplink data channel in the random access procedure of FIG. 3. According to an embodiment, sets of random access preambles which may be transmitted by the UE including the WUR may be transmitted to the UE as system information. The UE may select the random access preamble from the set received by the UE, and may transmit the random access preamble in the step 310 of the random access procedure of FIG. 3, based on the selected random access preamble. According to an embodiment, after reporting the capability information for the WUR, the UE may receive information indicating whether to use the WUR from the BS through higher layer signaling or a physical signal.

According to an embodiment, when the BS supports the UE including the WUR (for example, when the BS has hardware capable of transmitting a wake-up signal), the BS may determine whether to use the WUR after receiving the capability information for the WUR from the UE. According to an embodiment, the BS may transmit to the UE a signal indicating whether to use the WUR or configuration information for reception of the wake-up signal. According to an embodiment, the BS may transmit to the UE at least one of indication information for enabling the UE to receive the wake-up signal and indication information for reporting that the BS transmits the wake-up signal. The UE may turn off the main radio after a slot configured by the BS (or defined in the standard) from a slot in which a signal is received, and may turn on the WUR for monitoring the wake-up signal. According to an embodiment, the UE may transmit to the BS at least one of a feedback indicating whether to use the WUR before turning off the main radio and a feedback indicating that the main radio is turned off and the WUR is turned on.

According to an embodiment, when the BS does not support the UE having the WUR, the BS may transmit to the UE a signal indicating that it is not possible to use the WUR, after receiving the capability information for the WUR from the UE. The UE may transmit to the BS a feedback indicating that the UE has received the signal indicating that it is not possible to use the WUR. According to an embodiment, the UE may use the existing power saving method (C-DRX or I-DRX) such as paging to perform an operation based on parameters of the existing power saving method configured by the BS.

According to various embodiments of the disclosure, after a procedure of reporting the capability of the UE having the WUR and regarding whether the BS supports (or allows) the WUR, the WUR of the UE may receive the wake-up signal to perform an operation of turning off the main radio of the UE. According to an embodiment, of course, the UE may perform procedures independently for an operation of turning on/off the main radio, an operation of reporting the capability of the UE having the WUR, or an operation regarding whether the BS supports the WUR. For example, even when the UE's capability reporting operation and the base station authorization procedure are not performed, the base station may transmit a signal to the UE indicating whether to use the wake-up receiver or configuring information for receiving the wake-up signal, and accordingly, a UE having the wake-up receiver among the UEs receiving the signal from the base station may perform the on/off of the main radio via the wake-up receiver. According to one embodiment, after the UE's capability reporting operation and the base station authorization procedure are performed, the operation of turning on/off the main radio via the wake-up receiver may be applied to all UEs in the cell supported by the base station (e.g., RRC_CONNECTED UEs, RRC_IDLE/RRC_INACTIVE UEs, or UEs accessing the cell (e.g., RRC_CONNECTED UEs)). The behavior of reporting the capability of the UE and, if the base station authorization procedure is not performed, the behavior of turning the main radio on/off via the wake-up receiver may apply to RRC_IDLE/RRC_INACTIVE UEs camping within a cell supported by a base station. In addition, various embodiments of the disclosure may include at least one of all, some, or combinations of some of various operations of the BS and the UE including the WUR described below.

Hereinafter, according to various embodiments of the disclosure, an operation of turning on or off the main radio of the UE having the WUR is described. Various embodiments of the disclosure may include at least one of all, some, or combinations of some of various operations of the BS and the UE including the WUR described below.

According to an embodiment, when the main radio of the UE is on, the UE may receive a downlink signal (or data) from the BS through the main radio. According to various embodiments of the disclosure, the main radio being ‘on’ may be expressed that the main radio is ‘on’ or the main radio is ‘active’, etc., but without being limited thereto, it may also be expressed in a similar or substantially identical meaning. According to an embodiment, the main radio being active may mean that specific components (e.g., Radio Frequency (RF), Baseband (BB), etc.) of the main radio are on, or may be defined by a standard (e.g., the 3GPP TS document). However, according to various embodiments of the disclosure, without being limited to the aforementioned description, the main radio being active may include performing a parameter having content identical or substantially similar thereto or performing an operation based on the parameter.

According to an embodiment, when the main radio of the UE is off, the UE may be regarded as being in a sleep duration or a downlink signal (or data) may not be received from the BS. According to various embodiments of the disclosure, the main radio being ‘off’ may be expressed that the main radio is ‘off’ or the main radio is ‘inactive’, etc., but without being limited thereto, it may also be expressed in a similar or substantially identical meaning. According to an embodiment, the main radio being inactive may mean that specific components (e.g., Radio Frequency (RF), Baseband (BB), etc.) of the main radio are off, or may be defined by a standard (e.g., the 3GPP TS document). However, according to various embodiments of the disclosure, without being limited to the aforementioned description, the main radio being inactive may include performing a parameter having content identical or substantially similar thereto or performing an operation based on the parameter.

Hereinafter, according to various embodiments of the disclosure, a procedure for waking up the main radio is described when the main radio is in a sleep state. According to an embodiment, an operation of waking up the main radio may be performed in combination with various operations based on various embodiments of the disclosure, or may be performed separately. In addition, the operation may not be essential components.

According to various embodiments of the disclosure, the BS may transmit the wake-up signal to the UE, when there is a channel or signal to be transmitted to the UE. The UE or the WUR may turn on the main radio by receiving the wake-up signal. According to an embodiment, an operation of receiving the wake-up signal may be an indication for waking up the main radio. According to an embodiment, the wake-up signal may include K information bits, and information indicating to wake up the main radio may be mapped to the K information bits. For example, when the information bit included in the wake-up signal is 1-bit information, ‘1’ may indicate ON, and ‘0’ may indicate OFF.

According to an embodiment, from a perspective of transmission of the BS, whether to transmit the wake-up signal at a certain timing before transmitting a channel or a signal may be pre-defined. From a perspective of reception of the UE, whether the UE is able to receive the wake-up signal at a certain timing before receiving the channel or the signal may be pre-defined.

According to an embodiment, the UE may transmit, to the BS, information on a time offset required between the wake-up signal and the channel/signal, and the BS may configure the time offset between the wake-up signal and the channel/signal to the UE, based on received information. According to an embodiment, the UE may transmit to the BS the information on the time offset required between the wake-up signal and the channel/signal through a UE capability information report procedure, or may transmit to the BS the information through an uplink data channel or a random access preamble in a random access procedure. Of course, without being limited thereto, the UE may transmit the information on the time offset to the BS through a higher-level signal or through various signals. The BS may configure the information on the time offset between the wake-up signal and the channel/signal to the UE through a downlink data of a random access contention resolution (e.g., message 4) or a random access response (e.g., message 2) in the random access procedure. Of course, without being limited thereto, the BS may configure the information on the time offset to the UE through a higher-level signal or through various signals.

According to various embodiments of the disclosure, in the presence of a periodic channel or periodic signal to be transmitted by the BS to the UE, instead of an operation in which the BS transmits a wake-up signal whenever there is a channel or signal to be transmitted, the UE or the WUR may turn on the main radio according to a period based on configuration information of the periodic channel or periodic signal which is configured from the BS.

According to an embodiment, the BS may transmit the wake-up signal in a first transmission of the periodic channel or the periodic signal, and may skip transmission of the wake-up signal when the channel or the signal is transmitted repeatedly at a later time. In this case, the UE or the WUR may turn on the main radio, based on a period depending on configuration information of the periodic channel or periodic signal, which is configured from the BS.

According to an embodiment, a type of the periodic channel or periodic signal transmitted and received by the BS and the UE may be pre-defined. According to an embodiment, the type of the periodic channel or periodic signal may be configured from the BS. The BS may configure the type of the periodic channel or periodic signal to the UE through a downlink data channel of a random access response (e.g., message 2) or random access contention resolution (e.g., message 4), or may configure the periodic channel or periodic signal to the UE through a higher-level signal indicating configuration information for receiving the wake-up signal or other higher-level signals.

According to various embodiments of the disclosure, when there is a channel or signal (e.g., Physical Random Access Channel (PRACH) or Scheduling Request (SR) or Buffer Status Report (BSR)) to be transmitted by the UE to the BS or when the UE has to perform L1/L3-based measurement, the UE or the WUR may turn on the main radio irrespective of the wake-up signal transmitted by the BS.

According to an embodiment, for uplink transmission from the UE to the BS or for the L1/L3-based measurement, the WUR may not apply the operation of receiving the wake-up signal and turning on/off the main radio of the UE.

According to an embodiment, the type of the uplink channel or uplink signal of the UE, which is transmitted irrespective of the operation of receiving the wake-up signal, or the L1/L3-based measurement may be pre-defined. According to an embodiment, the type of the uplink channel or uplink signal or the L1/L3-based measurement may be configured from the BS. The BS may configure the type of the uplink channel or uplink signal or the L1/L3-based measurement to the UE through a downlink data channel of a random access response (e.g., message 2) or random access contention resolution (e.g., message 4), or may configure type of the uplink channel or uplink signal or the L1/L3-based measurement to the UE through a higher-level signal indicating configuration information for receiving the wake-up signal or other higher-level signals.

Hereinafter, according to various embodiments of the disclosure, a procedure for turning off the main radio is described when the main radio is in an On state. According to an embodiment, when the main radio is in the On state, an operation of waking up the main radio may be performed in combination with various operations based on various embodiments of the disclosure, or may be performed separately. In addition, the operation may not be essential components.

According to various embodiments of the disclosure, the BS may transmit a sleep signal to the UE, when there is no channel or signal to be transmitted to the UE. The UE or the WUR may receive the sleep signal to turn off the main radio. According to an embodiment, an operation of receiving the sleep signal may be an indication for sleeping the main radio. According to an embodiment, the sleep signal may consist of a sequence independent of the wake-up signal. According to an embodiment, the sleep signal may include information to which information indicating to sleep the main radio is mapped in K information bits included in the wake-up signal. For example, in case of the 1-bit information, ‘0’ may indicate OFF, and ‘1’ may indicate ON.

According to various embodiments of the disclosure, the main radio of the UE may be off when a set condition is satisfied. According to an embodiment, the condition set to the main radio may be a case where the main radio fails to detect or decode a downlink control channel and a specific channel or signal during a set duration. According to an embodiment, the BS may configure configuration information (e.g., information including a duration and a specific channel or signal) used by the UE for determining to turn off the main radio to the UE through a higher-level signal indicating configuration information for receiving the wake-up signal or other higher-level signals.

According to various embodiments of the disclosure, the main radio of the UE may always be off after receiving one channel or signal. According to an embodiment, after the WUR receives the wake-up signal from the BS and the main radio is turned on to receive a channel or signal, the main radio may be off. According to an embodiment, a time required until the main radio is off after the reception of the channel or signal is complete may be pre-defined. According to an embodiment, the UE may transmit information on a time required until the main radio is off to the BS, and the BS may configure the required time to the UE, based on the received information. According to an embodiment, the information on the required time, transmitted by the UE, may be transmitted to the BS through a UE capability information report procedure. According to an embodiment, the information on the required time, transmitted by the UE, may be transmitted to the BS through a random access preamble or an uplink data channel. Of course, without being limited thereto, the UE may transmit the information on the required time to the BS through a higher-level signal. The BS may configure the information on the required time, to be transmitted to the UE, to the UE through a downlink data channel of a random access response (e.g., message 2) or random access contention resolution (e.g., message 4). Of course, without being limited thereto, the BS may configure the information on the requited time to the UE by using the higher-level signal.

Hereinafter, according to various embodiments of the disclosure, when the UE or the main radio of the UE is in an RRC_CONNECTED state, the UE may perform PDCCH reception by setting Connected Mode DRX (C-DRX) and waking up the main radio every DRX cycle. According to an embodiment, when the UE or the main radio of the UE is in the RRC_CONNECTED state, the UE (or the main radio) may be configured to receive a signal indicating whether to receive the PDCCH in a next DRX cycle.

According to an embodiment, when the main radio is in an RRC_IDLE/RRC_INACTIVE state, the UE may receive a paging PDCCH by setting Idle mode DRX (I-DRX) and waking up the main radio every paging cycle. According to an embodiment, when the UE or the main radio of the UE is in the RRC_CONNECTED state, the UE (or the main radio) may be configured to receive a signal indicating whether to receive the paging PDCCH in a next DRX cycle.

Hereinafter, according to various embodiments of the disclosure, an embodiment for a procedure of the UE operating with the WUR is provided when an operation of indicating ON/OFF based on wake-up signal reception of the WUR and main radio and an operation based on the configuration of the C-DRX or I-DRX exist together. According to an embodiment, an operation of the UE related to the RRC CONNECTED/IDLE/INACTIVE or the main radio of the UE may be performed in combination with various operations based on various embodiments of the disclosure, or may be performed separately. In addition, the operation may not be essential components.

According to various embodiments of the disclosure, when the UE having the WUR receives the wake-up signal to perform an operation of turning on and off the main radio of the UE, the UE may not configure the C-DRX or the I-DRX or may not perform an operation based on the configuration. In this case, instead of performing actions according to the C-DRX or I-DRX configurations and configurations, the UE can turn on the UE's main radio when the UE receives a wake-up signal to wake up the main radio, and can listen to the physical downlink control channel (PDCCH) and physical downlink shared channel (PDSCH) defined or set to be received by the C-DRX or I-DRX, respectively.

According to an embodiment, when the UE or the main radio of the UE is in the RRC_CONNECTED state and an operation performed by the WUR is configured or activated from the BS, the UE may turn on the main radio if the WUR receives a wake-up signal instructing to wake up the main radio, and may perform an operation related to the C-DRX configured from the BS (e.g., the main radio receives a PDCCH within drx onDurationTimer every DRX cycle). According to an embodiment, the UE (or the main radio) may not perform an operation configured to receive a signal (e.g., DCI format 2_6) instructing the UE whether to receive the PDCCH at a next DRX cycle. According to an embodiment, when the UE or the main radio of the UE is in the RRC IDLE/INACTIVE state and an operation performed by the WUR is configured or activated from the BS, the UE may turn on the main radio if the WUR receives a wake-up signal instructing to wake up the main radio, and may perform an operation related to the I-DRX configured from the BS (e.g., the main radio wakes up every paging cycle to receive a paging PDCCH). According to an embodiment, the UE (or the main radio) may not perform an operation configured to receive a signal (e.g., DCI format 2_7) instructing the UE whether to receive the paging PDCCH at a next paging cycle.

According to an embodiment, the UE may perform an operation for waking up the WUR based on various embodiments of the disclosure and the main radio based on the wake-up signal, instead of the operation based on the configuration related to the C-DRX or I-DRX. If the operation performed by the WUR is deactivated from the BS, operations related to the C-DRX or I-DRX configured from the BS may be performed again.

According to various embodiments of the disclosure, when the operation performed by the WUR of the UE is configured or activated from the BS or when the UE or the WUR receives the wake-up signal to turn on the main radio, the UE may transition to the RRC_CONNECTED state or may transition to the RRC_IDLE or RRC_INACTIVE state. According to an embodiment, whether the UE is able to transition to a certain state may be pre-determined, or may be determined by a higher-layer signal for the configuration of the operation of the WUR or by a separate higher-layer signal.

As one example of when the information about the transition of the device (including information about what RRC state the main radio will be determined to be when the main radio is turned on by the wake-up signal) is predetermined, according to one embodiment, the state of the main radio may follow the state of the most recent time the main radio was turned on and off immediately prior to the current turn-on time. As another example of when the information about the transition of the device is predetermined, the state of the main radio may not be affected by whether the wake-up receiver behavior is configured and enabled, according to an embodiment. For example, the state of the main radio of the UE may be determined by a higher order signal indicating at least one of RRC_CONNECTED, RRC_IDLE, or RRC_INACTIVE, and the UE may determine that the state of the main radio is unchanged by whether the wake-up receiver behavior is configured and enabled.

According to an embodiment, the wake-up signal may include K information bits, and information on at least one of whether the main radio transitions to the RRC_CONNECTED state, transitions to the RRC_IDLE state, or transitions to the RRC_INACTIVE state may be mapped to the K information bits.

According to an embodiment, when the UE or the main radio of the UE is in the RRC_CONNECTED state, the main radio may wake up to receive a PDCCH every DRX cycle through the C-DRX configured from the BS, based on the determined state of the UE, or the UE (or the main radio) may be configured from the BS to receive a signal instructing the UE whether to receive the PDCCH at a next DRX cycle. According to an embodiment, when an operation for turning off the main radio based on various embodiments is performed while the UE receives the PDCCH (for example, in a duration of receiving the PDCCH), the UE may preferentially perform a procedure for turning off the main radio.

According to an embodiment, when the UE or the main radio of the UE is in the RRC_IDLE/INACTIVE state, the main radio may wake up every paging cycle due to the I-DRX configured from the BS, and may receive a paging PDCCH. The UE (or the main radio) may be configured from the BS to receive a signal instructing the UE whether to receive the paging PDCCH at a next paging cycle. When an operation of turning off the main radio based on various embodiments is performed while the paging PDCCH is received (for example, in a duration of receiving the paging PDCCH), the UE may preferentially perform a procedure for turning off the main radio.

According to various embodiments of the disclosure, the aforementioned various operations of the UE (or the main radio) may be performed regardless of order, and the UE and the main radio may be interchangeably used as a subject of the operation.

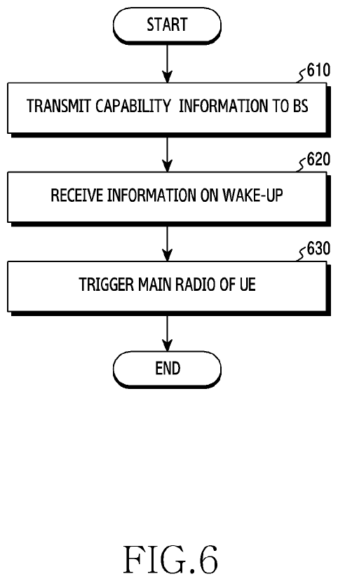

FIG. 6 illustrates an operational flow of a UE for transmitting and receiving a wake-up signal according to various embodiments of the disclosure. Various embodiments of the disclosure may include at least one of all, some, or a combination of some of the steps described below, and it is obvious that an advantage to be achieved in the disclosure may be obtained from not only all of steps of FIG. 6 but also each step of FIG. 6. In addition, the steps of FIG. 6 may be one example for an embodiment of the disclosure, and various embodiments performed by the UE (or the main radio) are not limited thereto.

In step 610, the UE may transmit capability information to the BS. According to an embodiment, the UE including a WUR may report to the BS that the UE is capable of waking up the main radio by using the WUR, or may report capability information indicating that the UE includes the WUR to the BS.

According to an embodiment, the UE may also report to the BS the capability information for the WUR through a UE capability information report procedure.

According to an embodiment, the UE may report the capability information for the WUR to the BS through at least one step of a random access preamble or an uplink data channel in the random access procedure. According to an embodiment, sets of random access preambles which may be transmitted by the UE including the WUR may be transmitted to the UE as system information. The UE may select the random access preamble from the set received by the UE, and may transmit the random access preamble, based on the selected random access preamble. According to an embodiment, after reporting the capability information for the WUR, the UE may receive information indicating whether to use the WUR from the BS through higher layer signaling or a physical signal.

According to an embodiment, when the BS supports the UE including the WUR (for example, when the BS has hardware capable of transmitting a wake-up signal), the BS may determine whether to use the WUR after receiving the capability information for the WUR from the UE. According to an embodiment, the UE may receive from the BS a signal indicating whether to use the WUR or configuration information for reception of the wake-up signal. According to an embodiment, the UE may receive from the BS at least one of indication information for enabling the UE to receive the wake-up signal and indication information for reporting that the BS transmits the wake-up signal. The UE may turn off the main radio after a slot configured by the BS (or defined in the standard) from a slot in which a signal is received, and may turn on the WUR for monitoring the wake-up signal. According to an embodiment, the UE may transmit to the BS at least one of a feedback indicating whether to use the WUR before turning off the main radio and a feedback indicating that the main radio is turned off and the WUR is turned on.

According to an embodiment, when the BS does not support the UE having the WUR, the UE may receive from the BS a signal indicating that it is not possible to use the WUR, after transmitting the capability information for the WUR to the BS. The UE may transmit to the BS a feedback indicating that the UE has received the signal indicating that it is not possible to use the WUR.

In step 620, the UE may receive information on wake-up from the BS. The information on the wake-up, received by the UE, may include a Wake-Up Signal (WUS) or a sleep signal.

In step 630, the UE may trigger a main radio of the UE.

Referring to step 620 or step 630, according to various embodiments of the disclosure, the UE may receive the wake-up signal from the BS. The UE or the WUR may turn on the main radio by receiving the wake-up signal. According to an embodiment, an operation of receiving the wake-up signal may be an indication for waking up the main radio. According to an embodiment, the wake-up signal may include K information bits, and information indicating to wake up the main radio may be mapped to the K information bits. For example, when the information bit included in the wake-up signal is 1-bit information, ‘1’ may indicate ON, and ‘0’ may indicate OFF.

According to an embodiment, from a perspective of reception of the UE, whether the UE is able to receive the wake-up signal at a certain timing before receiving a channel or a signal may be pre-defined.

According to an embodiment, the UE may transmit, to the BS, information on a time offset required between the wake-up signal and the channel/signal, and the BS may configure the time offset between the wake-up signal and the channel/signal to the UE, based on received information. According to an embodiment, the UE may transmit to the BS the information on the time offset required between the wake-up signal and the channel/signal through a UE capability information report procedure, or may transmit to the BS the information through an uplink data channel or a random access preamble in a random access procedure. Of course, without being limited thereto, the UE may transmit the information on the time offset to the BS through a higher-level signal or through various signals. The BS may configure the information on the time offset between the wake-up signal and the channel/signal to the UE through a downlink data of a random access contention resolution (e.g., message 4) or a random access response (e.g., message 2) in the random access procedure. Of course, without being limited thereto, the BS may configure the information on the time offset to the UE through a higher-level signal or through various signals.

According to various embodiments of the disclosure, in the presence of a periodic channel or periodic signal to be transmitted by the BS to the UE, instead of an operation in which the BS transmits a wake-up signal whenever there is a channel or signal to be transmitted, the UE or the WUR may turn on the main radio according to a period based on configuration information of the periodic channel or periodic signal which is configured from the BS.

According to an embodiment, the BS may transmit the wake-up signal in a first transmission of the periodic channel or the periodic signal, and may skip transmission of the wake-up signal when the channel or the signal is transmitted repeatedly at a later time. In this case, the UE or the WUR may turn on the main radio, based on a period depending on configuration information of the periodic channel or periodic signal, which is configured from the BS.

According to an embodiment, a type of the periodic channel or periodic signal transmitted and received by the BS and the UE may be pre-defined. According to an embodiment, the type of the periodic channel or periodic signal may be configured from the BS. The BS may configure the type of the periodic channel or periodic signal to the UE through a downlink data channel of a random access response (e.g., message 2) or random access contention resolution (e.g., message 4), or may configure the type of the periodic channel or periodic signal to the UE through a higher-level signal indicating configuration information for receiving the wake-up signal or other higher-level signals.

According to various embodiments of the disclosure, when there is a channel or signal (e.g., Physical Random Access Channel (PRACH) or Scheduling Request (SR) or Buffer Status Report (BSR)) to be transmitted by the UE to the BS or when the UE has to perform L1/L3-based measurement, the UE or the WUR may turn on the main radio irrespective of the wake-up signal transmitted by the BS.

According to an embodiment, for uplink transmission from the UE to the BS or for the L1/L3-based measurement, the WUR may not apply the operation of receiving the wake-up signal and turning on/off the main radio of the UE.

According to an embodiment, the type of the uplink channel or uplink signal of the UE, which is transmitted irrespective of the operation of receiving the wake-up signal, or the L1/L3-based measurement may be pre-defined. According to an embodiment, the type of the uplink channel or uplink signal or the L1/L3-based measurement may be configured from the BS. The BS may configure the type of the uplink channel or uplink signal or the L1/L3-based measurement to the UE through a downlink data channel of a random access response (e.g., message 2) or random access contention resolution (e.g., message 4), or may configure the type of the uplink channel or uplink signal or the L1/L3-based measurement to the UE through a higher-level signal indicating configuration information for receiving the wake-up signal or other higher-level signals.

Referring to step 620 or step 630, according to various embodiments of the disclosure, the BS may transmit a sleep signal (e.g., an inactivation signal) when there is no channel or signal to be transmitted to the UE. The UE or the WUR may receive the sleep signal to turn off the main radio. According to an embodiment, an operation of receiving the sleep signal may be an indication for sleeping the main radio. According to an embodiment, the sleep signal may consist of a sequence independent of the wake-up signal. According to an embodiment, the sleep signal may include information to which information indicating to sleep the main radio is mapped in K information bits included in the wake-up signal. For example, in case of the 1-bit information, ‘0’ may indicate OFF, and ‘1’ may indicate ON.

According to various embodiments of the disclosure, the main radio of the UE may be off when a set condition is satisfied. According to an embodiment, the condition set to the main radio may be a case where the main radio fails to detect or decode a downlink control channel and a specific channel or signal during a set duration. According to an embodiment, the BS may configure configuration information (e.g., information including a duration and a specific channel or signal) used by the UE for determining to turn off the main radio to the UE through a higher-level signal indicating configuration information for receiving the wake-up signal or other higher-level signals.

According to various embodiments of the disclosure, the main radio of the UE may always be off after receiving one channel or signal. According to an embodiment, after the WUR receives the wake-up signal from the BS and the main radio is turned on to receive a channel or signal, the main radio may be off. According to an embodiment, a time required until the main radio is off after the reception of the channel or signal is complete may be pre-defined. According to an embodiment, the UE may transmit information on a time required until the main radio is off to the BS, and the BS may configure the required time to the UE, based on the received information. According to an embodiment, the information on the required time, transmitted by the UE, may be transmitted to the BS through a UE capability information report procedure. According to an embodiment, the information on the required time, transmitted by the UE, may be transmitted to the BS through a random access preamble or an uplink data channel. Of course, without being limited thereto, the UE may transmit the information on the required time to the BS through a higher-level signal. The BS may configure the information on the required time, to be transmitted to the UE, to the UE through a downlink data channel of a random access response (e.g., message 2) or random access contention resolution (e.g., message 4). Of course, without being limited thereto, the BS may configure the information on the requited time to the UE by using the higher-level signal.

Referring to step 620 or step 630, according to various embodiments of the disclosure, when the UE having the WUR receives the wake-up signal to perform an operation of turning on and off the main radio of the UE, the UE may not configure the C-DRX or the I-DRX or may not perform an operation based on the configuration.

According to an embodiment, when the UE or the main radio of the UE is in the RRC_CONNECTED state and when an operation performed by the WUR is configured or activated from the BS, the UE may perform an operation related to a C-DRX configured from the BS (for example, the main radio wakes up every DRX cycle to receive a PDCCH). According to an embodiment, the UE (or the main radio) may not perform an operation configured to receive a signal instructing the UE whether to receive the PDCCH at a next DRX cycle.

According to an embodiment, when the UE or the main radio of the UE is in the RRC_IDLE/INACTIVE state and an operation performed by the WUR is configured or activated from the BS, the UE may perform an operation related to the I-DRX configured from the BS (e.g., the main radio wakes up every paging cycle to receive a paging PDCCH). According to an embodiment, the UE (or the main radio) may not perform an operation configured to receive a signal instructing the UE whether to receive the paging PDCCH at a next paging cycle.

According to an embodiment, the UE may perform an operation for waking up the WUR based on various embodiments of the disclosure and the main radio based on the wake-up signal, instead of the operation based on the configuration related to the C-DRX or I-DRX. If the operation performed by the WUR is deactivated from the BS, operations related to the C-DRX or I-DRX configured from the BS may be performed again.

According to various embodiments of the disclosure, when the operation performed by the WUR of the UE is configured or activated from the BS or when the UE or the WUR receives the wake-up signal to turn on the main radio, the UE may transition to the RRC_CONNECTED state or may transition to the RRC_IDLE or RRC_INACTIVE state. According to an embodiment, whether the UE is able to transition to a certain state may be pre-determined, or may be determined by a higher-layer signal for the configuration of the operation of the WUR or by a separate higher-layer signal.

According to an embodiment, the wake-up signal may include K information bits, and information on at least one of whether the main radio transitions to the RRC_CONNECTED state, transitions to the RRC_IDLE state, or transitions to the RRC_INACTIVE state may be mapped to the K information bits.

According to an embodiment, when the UE or the main radio of the UE is in the RRC_CONNECTED state, the main radio may wake up to receive a PDCCH every DRX cycle through the C-DRX configured from the BS, based on the determined state of the UE, or the UE (or the main radio) may be configured from the BS to receive a signal instructing the UE whether to receive the PDCCH at a next DRX cycle. According to an embodiment, when an operation for turning off the main radio based on various embodiments is performed while the UE receives the PDCCH (for example, in a duration of receiving the PDCCH), the UE may preferentially perform a procedure for turning off the main radio.

According to an embodiment, when the UE or the main radio of the UE is in the RRC_IDLE/INACTIVE state, the main radio may wake up every paging cycle due to the I-DRX configured from the BS, and may receive a paging PDCCH. The UE (or the main radio) may be configured from the BS to receive a signal instructing the UE whether to receive the paging PDCCH at a next paging cycle. When an operation of turning off the main radio based on various embodiments is performed while the paging PDCCH is received (for example, in a duration of receiving the paging PDCCH), the UE may preferentially perform a procedure for turning off the main radio.

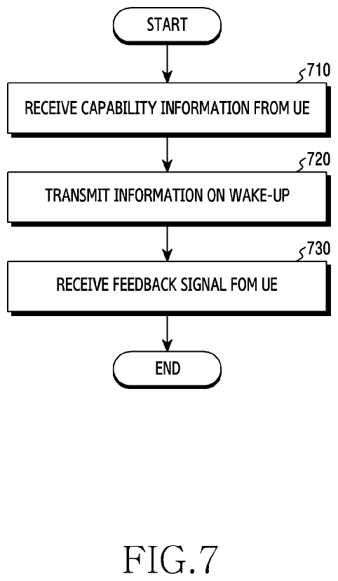

FIG. 7 illustrates an operational flow of a BS for transmitting a wake-up signal according to various embodiments of the disclosure. Various embodiments of the disclosure may include at least one of all, some, or a combination of some of the steps described below, and it is obvious that an advantage to be achieved in the disclosure may be obtained from not only all of steps of FIG. 7 but also each step of FIG. 7. In addition, the steps of FIG. 7 may be one example for an embodiment of the disclosure, and various embodiments performed by the BS are not limited thereto.

In step 710, the BS may receive capability information from a UE. According to an embodiment, the BS may be reported from the UE including a WUR that the UE is capable of waking up a main radio by using the WUR, or may be reported of capability information indicating that the UE includes the WUR from the UE.

According to an embodiment, the BS may be reported of the capability information for the WUR from the UE through a UE capability information report procedure.

According to an embodiment, the UE may be reported of the capability information for the WUR from the UE through at least one step of a random access preamble or an uplink data channel in the random access procedure. According to an embodiment, sets of random access preambles which may be transmitted by the UE including the WUR may be transmitted to the UE as system information. The UE may select the random access preamble from the set received by the UE, and the BS may receive the random access preamble from the UE, based on the random access preamble selected by the UE. According to an embodiment, after the capability information for the WUR is reported from the UE, the BS may transmit information indicating whether to use the WUR to the UE through higher layer signaling or a physical signal.

According to an embodiment, when the BS supports the UE including the WUR (for example, when the BS has hardware capable of transmitting a wake-up signal), the BS may determine whether to use the WUR after receiving the capability information for the WUR from the UE. According to an embodiment, the BS may transmit to the UE a signal indicating whether to use the WUR or configuration information for reception of the wake-up signal. According to an embodiment, the BS may transmit to the UE at least one of indication information for enabling the UE to receive the wake-up signal and indication information for reporting that the BS transmits the wake-up signal. The UE may turn off the main radio after a slot configured by the BS (or defined in the standard) from a slot in which a signal is received, and may turn on the WUR for monitoring the wake-up signal.

In step 720, the BS may transmit information on wake-up to the UE. The information on the wake-up, transmitted by the BS, may include a Wake-Up Signal (WUS) or a sleep signal.

Referring to step 720, according to various embodiments of the disclosure, the BS may transmit the wakeup signal to the UE, when there is a channel or signal to be transmitted to the UE. The UE or the WUR may turn on the main radio by receiving the wake-up signal. According to an embodiment, an operation of receiving the wake-up signal may be an indication for waking up the main radio. According to an embodiment, the wake-up signal may include K information bits, and information indicating to wake up the main radio may be mapped to the K information bits. For example, when the information bit included in the wake-up signal is 1-bit information, ‘1’ may indicate ON, and ‘0’ may indicate OFF.

According to an embodiment, from a perspective of transmission of the BS, whether to transmit the wake-up signal at a certain timing before transmitting a channel or a signal may be pre-defined. From a perspective of reception of the UE, whether the UE is able to receive the wake-up signal at a certain timing before receiving the channel or the signal may be pre-defined.

According to an embodiment, the UE may transmit, to the BS, information on a time offset required between the wake-up signal and the channel/signal, and the BS may configure the time offset between the wake-up signal and the channel/signal to the UE, based on received information. According to an embodiment, the UE may transmit to the BS the information on the time offset required between the wake-up signal and the channel/signal through a UE capability information report procedure, or may transmit to the BS the information through an uplink data channel or a random access preamble in a random access procedure. Of course, without being limited thereto, the UE may transmit the information on the time offset to the BS through a higher-level signal or through various signals. The BS may configure the information on the time offset between the wake-up signal and the channel/signal to the UE through a downlink data of a random access contention resolution (e.g., message 4) or a random access response (e.g., message 2) in the random access procedure. Of course, without being limited thereto, the BS may configure the information on the time offset to the UE through a higher-level signal or through various signals.

According to various embodiments of the disclosure, in the presence of a periodic channel or periodic signal to be transmitted by the BS to the UE, instead of an operation in which the BS transmits a wake-up signal whenever there is a channel or signal to be transmitted, the UE or the WUR may turn on the main radio according to a period based on configuration information of the periodic channel or periodic signal which is configured from the BS.

According to an embodiment, the BS may transmit the wake-up signal in a first transmission of the periodic channel or the periodic signal, and may skip transmission of the wake-up signal when the channel or the signal is transmitted repeatedly at a later time. In this case, the UE or the WUR may turn on the main radio, based on a period depending on configuration information of the periodic channel or periodic signal, which is configured from the BS.

According to an embodiment, a type of the periodic channel or periodic signal transmitted and received by the BS and the UE may be pre-defined. According to an embodiment, the type of the periodic channel or periodic signal may be configured from the BS. The BS may configure the type of the periodic channel or periodic signal to the UE through a downlink data channel of a random access response (e.g., message 2) or random access contention resolution (e.g., message 4), or may configure the type of the periodic channel or periodic signal to the UE through a higher-level signal indicating configuration information for receiving the wake-up signal or other higher-level signals.

According to various embodiments of the disclosure, when there is a channel or signal (e.g., Physical Random Access Channel (PRACH) or Scheduling Request (SR) or Buffer Status Report (BSR)) to be transmitted by the UE to the BS or when the UE has to perform L1/L3-based measurement, the UE or the WUR may turn on the main radio irrespective of the wake-up signal transmitted by the BS.

According to an embodiment, for uplink transmission from the UE to the BS or for the L1/L3-based measurement, the WUR may not apply the operation of receiving the wake-up signal and turning on/off the main radio of the UE.

According to an embodiment, the type of the uplink channel or uplink signal of the UE, which is transmitted irrespective of the operation of receiving the wake-up signal, or the L1/L3-based measurement may be pre-defined. According to an embodiment, the type of the uplink channel or uplink signal or the L1/L3-based measurement may be configured from the BS. The BS may configure the type of the uplink channel or uplink signal or the L1/L3 -based measurement to the UE through a downlink data channel of a random access response (e.g., message 2) or random access contention resolution (e.g., message 4), or may configure the type of the uplink channel or uplink signal or the L1/L3-based measurement to to the UE through a higher-level signal indicating configuration information for receiving the wake-up signal or other higher-level signals.

Referring to step 720, the BS may transmit a sleep signal to the UE, when there is no channel or signal to be transmitted to the UE. The UE or the WUR may receive the sleep signal to turn off the main radio. According to an embodiment, an operation of receiving the sleep signal may be an indication for sleeping the main radio. According to an embodiment, the sleep signal may consist of a sequence independent of the wake-up signal. According to an embodiment, the sleep signal may include information to which information indicating to sleep the main radio is mapped in K information bits included in the wake-up signal. For example, in case of the 1-bit information, ‘0’ may indicate OFF, and ‘1’ may indicate ON.

According to various embodiments of the disclosure, the main radio of the UE may be off when a set condition is satisfied. According to an embodiment, the condition set to the main radio may be a case where the main radio fails to detect or decode a downlink control channel and a specific channel or signal during a set duration. According to an embodiment, the BS may configure configuration information (e.g., information including a duration and a specific channel or signal) used by the UE for determining to turn off the main radio to the UE through a higher-level signal indicating configuration information for receiving the wake-up signal or other higher-level signals.

According to various embodiments of the disclosure, the main radio of the UE may always be off after receiving one channel or signal. According to an embodiment, after the WUR receives the wake-up signal from the BS and the main radio is turned on to receive a channel or signal, the main radio may be off. According to an embodiment, a time required until the main radio is off after the reception of the channel or signal is complete may be pre-defined. According to an embodiment, the UE may transmit information on a time required until the main radio is off to the BS, and the BS may configure the required time to the UE, based on the received information. According to an embodiment, the information on the required time, transmitted by the UE, may be transmitted to the BS through a UE capability information report procedure. According to an embodiment, the information on the required time, transmitted by the UE, may be transmitted to the BS through a random access preamble or an uplink data channel. Of course, without being limited thereto, the UE may transmit the information on the required time to the BS through a higher-level signal. The BS may configure the information on the required time, to be transmitted to the UE, to the UE through a downlink data channel of a random access response (e.g., message 2) or random access contention resolution (e.g., message 4). Of course, without being limited thereto, the BS may configure the information on the requited time to the UE by using the higher-level signal.

Referring to step 720, according to various embodiments of the disclosure, an embodiment for a procedure of the UE operating with the WUR is provided when an operation of indicating ON/OFF based on wake-up signal reception of the WUR and main radio and an operation based on the configuration of the C-DRX or I-DRX exist together. According to an embodiment, an operation of the UE related to the RRC_CONNECTED/IDLE/INACTIVE or the main radio of the UE may be performed in combination with various operations based on various embodiments of the disclosure, or may be performed separately. In addition, the operation may not be essential components.

According to various embodiments of the disclosure, when the UE having the WUR receives the wake-up signal to perform an operation of turning on and off the main radio of the UE, the UE may not configure the C-DRX or the I-DRX or may not perform an operation based on the configuration.

According to an embodiment, when the UE or the main radio of the UE is in the RRC_CONNECTED state and when an operation performed by the WUR is configured or activated from the BS, the UE may perform an operation related to a C-DRX configured from the BS (for example, the main radio wakes up every DRX cycle to receive a PDCCH). According to an embodiment, the UE (or the main radio) may not perform an operation configured to receive a signal instructing the UE whether to receive the PDCCH at a next DRX cycle.

According to an embodiment, when the UE or the main radio of the UE is in the RRC_IDLE/INACTIVE state and an operation performed by the WUR is configured or activated from the BS, the UE may perform an operation related to the I-DRX configured from the BS (e.g., the main radio wakes up every paging cycle to receive a paging PDCCH). According to an embodiment, the UE (or the main radio) may not perform an operation configured to receive a signal instructing the UE whether to receive the paging PDCCH at a next paging cycle.

According to an embodiment, the UE may perform an operation for waking up the WUR based on various embodiments of the disclosure and the main radio based on the wake-up signal, instead of the operation based on the configuration related to the C-DRX or I-DRX. If the operation performed by the WUR is deactivated from the BS, operations related to the C-DRX or I-DRX configured from the BS may be performed again.

According to various embodiments of the disclosure, when the operation performed by the WUR of the UE is configured or activated from the BS or when the UE or the WUR receives the wake-up signal to turn on the main radio, the UE may transition to the RRC_CONNECTED state or may transition to the RRC_IDLE or RRC_INACTIVE state. According to an embodiment, whether the UE is able to transition to a certain state may be pre-determined, or may be determined by a higher-layer signal for the configuration of the operation of the WUR or by a separate higher-layer signal.

According to an embodiment, the wake-up signal may include K information bits, and information on at least one of whether the main radio transitions to the RRC_CONNECTED state, transitions to the RRC_IDLE state, or transitions to the RRC_INACTIVE state may be mapped to the K information bits.

According to an embodiment, when the UE or the main radio of the UE is in the RRC_CONNECTED state, the main radio may wake up to receive a PDCCH every DRX cycle through the C-DRX configured from the BS, based on the determined state of the UE, or the UE (or the main radio) may be configured from the BS to receive a signal instructing the UE whether to receive the PDCCH at a next DRX cycle. According to an embodiment, when an operation for turning off the main radio based on various embodiments is performed while the UE receives the PDCCH (for example, in a duration of receiving the PDCCH), the UE may preferentially perform a procedure for turning off the main radio.

According to an embodiment, when the UE or the main radio of the UE is in the RRC_IDLE/INACTIVE state, the main radio may wake up every paging cycle due to the I-DRX configured from the BS, and may receive a paging PDCCH. The UE (or the main radio) may be configured from the BS to receive a signal instructing the UE whether to receive the paging PDCCH at a next paging cycle. When an operation of turning off the main radio based on various embodiments is performed while the paging PDCCH is received (for example, in a duration of receiving the paging PDCCH), the UE may preferentially perform a procedure for turning off the main radio.

In step 730, the BS may receive a feedback signal from the UE.

According to an embodiment, the BS may receive from the UE at least one of a feedback indicating whether to use the WUR before turning off the main radio and a feedback indicating that the main radio is turned off and the WUR is turned on.

According to an embodiment, when the BS does not support the UE having the WUR, the BS may transmit to the UE a signal indicating that it is not possible to use the WUR, after receiving the capability information for the WUR from the UE. The BS may receive from the UE a feedback indicating that the UE has received the signal indicating that it is not possible to use the WUR.

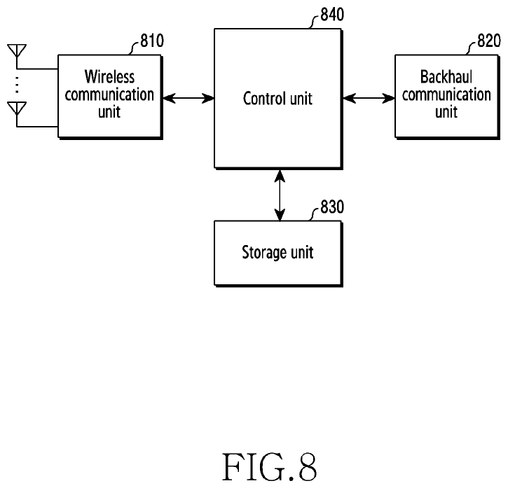

FIG. 8 illustrates a functional structure of a BS according to various embodiments of the disclosure. According to various embodiments of the disclosure, for convenience, the base station may be referred to as a network. The structure exemplified in FIG. 8 may be understood as a structure of the base station. Hereinafter, the term ‘. . . unit’, ‘. . . device’, or the like implies a unit of processing at least one function or operation, and may be implemented in hardware or software or in combination of the hardware and the software.

Referring to FIG. 8, the BS may include a wireless communication unit 810, a backhaul communication unit 820, a storage unit 830, and a control unit 840.

The wireless communication unit 810 performs functions for transmitting and receiving a signal through a radio channel. For example, the wireless communication unit 810 performs a function of conversion between a baseband signal and a bit-stream according to a physical layer standard of a system. For example, in data transmission, the wireless communication unit 810 generates complex symbols by coding and modulating a transmission bit-stream. In addition, in data reception, the wireless communication unit 810 restores a reception bit-stream by demodulating and decoding a baseband signal. In addition, the wireless communication unit 810 up-converts a baseband signal into a Radio Frequency (RF) signal and thereafter transmits the RF signal through an antenna, and down-converts an RF signal received through the antenna into a baseband signal.

For this, the wireless communication unit 810 may include a transmission filter, a reception filter, an amplifier, a mixer, an oscillator, a Digital to Analog Converter (DAC), an Analog to Digital Converter (ADC), or the like. In addition, the wireless communication unit 810 may include a plurality of transmission/reception paths. Further, the wireless communication unit 810 may include at least one antenna array constructed of a plurality of antenna elements. From a hardware aspect, the wireless communication unit 810 may be constructed of a digital unit and an analog unit, and the analog unit may be constructed of a plurality of sub-units according to operating power, operating frequency, or the like.

The wireless communication unit 810 may transmit/receive a signal. To this end, the wireless communication unit 810 may include at least one transceiver. For example, the wireless communication unit 810 may transmit a synchronization signal, a reference signal, system information, a message, control information, or data. In addition, the wireless communication unit 810 may perform beamforming.

The wireless communication unit 810 transmits and receives a signal as described above. Accordingly, the wireless communication unit 810 may be referred to as a transmitter, a receiver, or a transceiver. In addition, in the following description, transmission and reception performed through a radio channel are used to imply that the aforementioned processing is performed by the wireless communication unit 810.

The backhaul communication unit 820 provides an interface for preforming communication with different nodes in a network. That is, the backhaul communication unit 820 converts a bit-stream transmitted from the BS to a different node, e.g., a different access node, a different base station, an upper node, a core network, or the like, into a physical signal, and converts a physical signal received from the different node into a bit-stream.

The storage unit 830 stores data such as a basic program, application program, configuration information, or the like for an operation of the base station. The storage unit 830 may include a memory. The storage unit 830 may be constructed of a volatile memory, a non-volatile memory, or a combination of the volatile memory and the non-volatile memory. In addition, the storage unit 830 provides the stored data according to a request of the control unit 840.

The control unit 840 controls overall operations of the base station. For example, the control unit 840 may transmit and receive a signal via the communication unit 810 or the backhaul communication unit 820. Further, the control unit 840 writes and reads data in the storage unit 830. In addition, the control unit 840 may perform functions of a protocol stack required in a communication specification. To this end, the control unit 840 may include at least one processor.

The structure of the BS illustrated in FIG. 8 is only an example of the BS, and the example of the BS performing various embodiments of the disclosure is not limited to the structure illustrated in FIG. 8. That is, the structure may be added, deleted, or changed in part according to various embodiments.

Although the BS is described as one entity in FIG. 8, the disclosure is not limited thereto. The BS according to various embodiments of the disclosure may be implemented to constitute an access network having not only an integrated deployment but also a distributed deployment. According to an embodiment, the BS may be divided into a Central Unit (CU) and a Digital Unit (DU). The CU may be implemented to perform functions of upper layers (e.g., Packet Data Convergence Protocol (RRC)), and the DU may be implemented to perform functions of lower layers (e.g., Medium Access Control (MAC), and Physical (PHY)). The DU of the BS may constitute beam coverage on a radio channel.

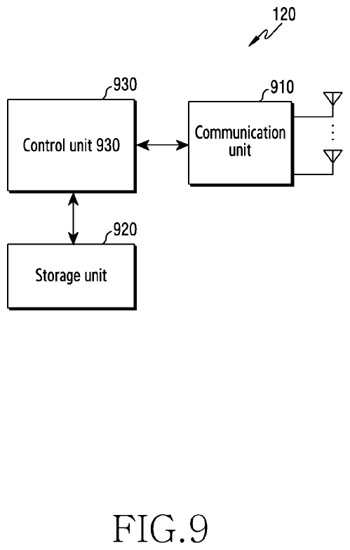

FIG. 9 illustrates a functional structure of a UE in a wireless communication system according to various embodiments of the disclosure. The structure exemplified in FIG. 9 may correspond to the structure of the UE. Hereinafter, the term ‘. . . unit’, ‘. . . device’, or the like implies a unit of processing at least one function or operation, and may be implemented in hardware or software or in combination of the hardware and the software.

Referring to FIG. 9, the UE may include a communication unit 910, a storage unit 920, and a control unit 930.

The communication unit 910 performs functions for transmitting and receiving a signal through a radio channel. For example, the communication unit 910 performs a function of conversion between a baseband signal and a bit-stream according to a physical layer standard of a system. For example, in data transmission, the communication unit 910 generates complex symbols by coding and modulating a transmission bit-stream. In addition, in data reception, the communication unit 910 restores a reception bit-stream by demodulating and decoding a baseband signal. In addition, the communication unit 910 up-converts a baseband signal into an RF signal and thereafter transmits the RF signal through an antenna, and down-converts an RF signal received through the antenna into a baseband signal. For example, the communication unit 910 may include a transmission filter, a reception filter, an amplifier, a mixer, an oscillator, a DAC, an ADC, or the like.

In addition, the communication unit 910 may include a plurality of transmission/reception paths. Further, the communication unit 910 may include an antenna unit. The communication unit 910 may include at least one antenna array constructed of a plurality of antenna elements. From a hardware aspect, the communication unit 910 may be constructed of a digital circuit and an analog circuit (e.g., a Radio Frequency Integrated Circuit (RFIC)). Herein, the digital circuit and the analog circuit may be implemented as one package. In addition, the communication unit 910 may include a plurality of RF chains. The communication unit 910 may perform beamforming. In order to assign a directivity depending on the setting of the control unit 930 to a signal to be transmitted/received, the communication unit 910 may apply a beamforming weight to the signal. According to an embodiment, the communication unit 910 may include a Radio Frequency (RF) block (or RF unit). The RF block may include a first RF circuity related to the antenna and a second RF circuity related to baseband processing. The first RF circuity may be referred to as RF-Antenna (RF-A). The second RF circuity may be referred to as RF-Baseband (RF-B).

In addition, the communication unit 910 may transmit/receive a signal. To this end, the communication unit 910 may include at least one transceiver. The communication unit 910 may receive a downlink signal. The downlink signal may include a Synchronization Signal (SS), a Reference Signal (RS) (e.g., Cell-specific Reference Signal (CRS), Demodulation (DM)-RS), system information (e.g., MIB, SIB, Remaining System Information (RMSI), Other System Information (OSI)), a configuration message, control information, or downlink data, etc. In addition, the communication unit 910 may transmit an uplink signal. The uplink signal may include a random access-related signal (e.g.,

Random Access Preamble (RAP) (Message 1 (Msg 1), message 3 (Msg3))), a reference signal (e.g., Sounding Reference Signal (SRS), DM-RS), or a Power Headroom Report (PHR), etc.

In addition, the communication unit 910 may include different communication modules to process signals of different frequency bands. Further, the communication unit 910 may include a plurality of communication modules to support a plurality of different radio access technologies. For example, the different radio access technologies may include a Bluetooth Low Energy (BLE), a Wireless Fidelity (WiFi), a WiFi Gigabyte (WiGig), a cellular network (e.g., Long Term Evolution (LTE), New Radio (NR)), or the like. In addition, the different frequency bands may include a Super High Frequency (SHF) (e.g., 2.5 GHz, 5 GHz) band and a millimeter wave (e.g., 38 GHz, 60 GHz, etc.) band. In addition, the communication unit 910 may use the same-type radio access technology on different frequency bands (e.g., an unlicensed band for Licensed Assisted Access (LAA), Citizens Broadband Radio Service (CBRS) (e.g., 3.5 GHz)).

The communication unit 910 transmits and receives a signal as described above. Accordingly, the communication unit 910 may be referred to as a transmitter, a receiver, or a transceiver. In addition, in the following description, transmission and reception performed through a radio channel are used to imply that the aforementioned processing is performed by the communication unit 910.

The storage unit 920 stores data such as a basic program, application program, configuration information, or the like for an operation of the UE. The storage unit 920 may be constructed of a volatile memory, a non-volatile memory, or a combination of the volatile memory and the non-volatile memory. In addition, the storage unit 920 provides the stored data according to a request of the control unit 930. According to various embodiments, the storage unit 920 may store each beam of a beam set to be operated in the UE or direction information on each beam of an auxiliary beam pair.

The control unit 930 controls overall operations of the UE. For example, the control unit 930 may transmit and receive a signal via the communication unit 910. Further, the control unit 930 writes and reads data in the storage unit 920. In addition, the control unit 930 may perform functions of a protocol stack required in a communication specification. To this end, the control unit 930 may include at least one processor. The control unit 930 may include at least one processor or micro-processor, or may be part of the processor. In addition, part of the communication unit 910 and the control unit 930 may be referred to as a Cellular Processor (CP). The control unit 930 may include various modules for performing communication. According to various embodiments, the control unit 930 may control the UE to perform operations based on various embodiments described above.

According to various embodiments of the disclosure, a method performed by a User Equipment (UE) in a wireless communication system may include receiving, by a Wake UP Receiver (WUR) of the UE, information on wake-up from a Base Station (BS), triggering activation or inactivation of a main radio of the UE, based on the information on wake-up, and receiving, by the main radio of the UE, a downlink signal from the BS, when the activation of the main radio of the UE is triggered.

According to an embodiment, the information on wake-up may include information indicating activation or inactivation of the main radio of the UE. The information indicating activation of the main radio of the UE may include at least one of information on an offset and configuration information on a period. The information on inactivation of the main radio of the UE may include configuration information related to a condition based on signal detection of the main radio.

According to an embodiment, the method may further include receiving configuration information on Connected Mode Discontinuous Reception (C-DRX) or Idle mode DRX (I-DRX) from the BS, triggering activation of the main radio in accordance with a DRX cycle, based on the configuration information on C-DRX or I-DRX and the information on wake-up, and when activation of the main radio is triggered, receiving, by the main radio of the UE, a downlink signal from the BS.

According to an embodiment, the information on wake-up may include information instructing to transition a state of the UE to one of a Radio Resource Control (RRC) connected state, an RRC idle state, and an RRC inactive state.

According to an embodiment, the method may further include transmitting, to the BS, capability information related to wake-up reception of the UE, receiving, from the BS, information related to whether the BS supports a wake-up reception function of the UE, and transmitting, to the BS, a feedback signal related to the wake-up reception, based on the information related to whether the BS supports the wake-up reception function of the UE.

According to various embodiments of the disclosure, a method performed by a BS in a wireless communication system may include transmitting information on wake-up to a WUR of a UE, receiving a feedback signal related to whether activation of a main radio of the UE is triggered, based on the information on wake-up, and transmitting a downlink signal to the main radio of the UE, when the activation of the main radio of the UE is triggered.

According to an embodiment, the information on wake-up may include information indicating activation or inactivation of the main radio of the UE. The information indicating activation of the main radio of the UE may include at least one of information on an offset and configuration information on a period. The information on inactivation of the main radio of the UE may include configuration information related to a condition based on signal detection of the main radio.

According to an embodiment, the method may further include transmitting configuration information on C-DRX or I-DRX to the UE, and when activation of the main radio is triggered in accordance with a DRX cycle, based on the configuration information on C-DRX or I-DRX and the information on wake-up, transmitting a downlink signal to the main radio of the UE.

According to an embodiment, the information on wake-up may include information instructing to transition a state of the UE to one of an RRC connected state, an RRC idle state, and an RRC inactive state.

According to an embodiment, the method may further include receiving, from the UE, capability information related to wake-up reception of the UE, transmitting, to the UE, information related to whether the BS supports a wake-up reception function of the UE, and receiving, from the UE, a feedback signal related to the wake-up reception, based on the information related to whether the BS supports the wake-up reception function of the UE.

According to various embodiments of the disclosure, a UE in a wireless communication system may include at least one transceiver and at least one processor operatively coupled to the at least one processor. The at least one processor may be configured to receive, by a WUR of the UE, information on wake-up from a BS, trigger activation or inactivation of a main radio of the UE, based on the information on wake-up, and receive, by the main radio of the UE, a downlink signal from the BS, when the activation of the main radio of the UE is triggered.

According to an embodiment, the information on wake-up may include information indicating activation or inactivation of the main radio of the UE. The information indicating activation of the main radio of the UE may include at least one of information on an offset and configuration information on a period. The information on inactivation of the main radio of the UE may include configuration information related to a condition based on signal detection of the main radio.

According to an embodiment, the at least one processor may be configured to receive configuration information on C-DRX or I-DRX from the BS, trigger activation of the main radio in accordance with a DRX cycle, based on the configuration information on C-DRX or I-DRX and the information on wake-up, and when activation of the main radio is triggered, receive, by the main radio of the UE, a downlink signal from the BS.

According to an embodiment, the information on wake-up may include information instructing to transition a state of the UE to one of an RRC connected state, an RRC idle state, and an RRC inactive state.

According to an embodiment, the at least one processor may be further configured to transmit, to the BS, capability information related to wake-up reception of the UE, receive, from the BS, information related to whether the BS supports a wake-up reception function of the UE, and transmit, to the BS a feedback signal related to the wake-up reception, based on the information related to whether the BS supports the wake-up reception function of the UE.

According to various embodiments of the disclosure, a BS in a wireless communication system may include at least one transceiver and at least one processor operatively coupled to the at least one processor. The at least one processor may be configured to transmit information on wake-up to a WUR of a UE, receive a feedback signal related to whether activation of a main radio of the UE is triggered, based on the information on wake-up, and transmit a downlink signal to the main radio of the UE, when the activation of the main radio of the UE is triggered.

According to an embodiment, the information on wake-up may include information indicating activation or inactivation of the main radio of the UE. The information indicating activation of the main radio of the UE may include at least one of information on an offset and configuration information on a period. The information on inactivation of the main radio of the UE may include configuration information related to a condition based on signal detection of the main radio.

According to an embodiment, the at least one processor may be further configured to transmit configuration information on C-DRX or I-DRX to the UE, and when activation of the main radio is triggered in accordance with a DRX cycle, based on the configuration information on C-DRX or I-DRX and the information on wake-up, transmit a downlink signal to the main radio of the UE.

According to an embodiment, the information on wake-up may include information instructing to transition a state of the UE to one of an RRC connected state, an RRC idle state, and an RRC inactive state.

According to an embodiment, the at least one processor may be further configured to receive, from the UE, capability information related to wake-up reception of the UE, transmit, to the UE, information related to whether the BS supports a wake-up reception function of the UE, and receive, from the UE, a feedback signal related to the wake-up reception, based on the information related to whether the BS supports the wake-up reception function of the UE.

The operations of embodiments described above may be realized by providing a memory unit storing corresponding program code in any component in a device. That is, a control unit the device may execute the aforementioned operations by reading and executing the program code stored in the memory unit by means of a processor or a Central Processing Unit (CPU). An entity, various components of a UE, a module, or the like, which is described in the disclosure, may operate by using a hardware circuit, for example, a complementary metal oxide semiconductor-based logic circuit, firmware, software, and/or a hardware circuit such as a combination of hardware and firmware and/or software embedded in a machine readable medium. For example, various electrical structures and methods may be implemented using electrical circuits such as transistors, logic gates, and application specific semiconductors.

Methods based on the embodiments disclosed in the claims and/or specification of the disclosure may be implemented in hardware, software, or a combination of both.

hen implemented in software, computer readable recording medium for storing one or more programs (i.e., software modules) may be provided. The one or more programs stored in the computer readable recording medium are configured for execution performed by one or more processors in the electronic device. The one or more programs include instructions for allowing the electronic device to execute the methods based on the embodiments disclosed in the claims and/or specification of the disclosure.

The program (i.e., the software module or software) may be stored in a random access memory, a non-volatile memory including a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs) or other forms of optical storage devices, and a magnetic cassette. Alternatively, the program may be stored in a memory configured in combination of all or some of these storage media. In addition, the configured memory may be plural in number.

Further, the program may be stored in an attachable storage device capable of accessing the electronic device through a communication network such as the Internet, an Intranet, a Local Area Network (LAN), a Wide LAN (WLAN), or a Storage Area Network (SAN) or a communication network configured by combining the networks. The storage device may have access to a device for performing an embodiment of the disclosure via an external port. In addition, an additional storage device on a communication network may have access to the device for performing the embodiment of the disclosure.

In the aforementioned specific embodiments of the disclosure, a component included in the disclosure is expressed in a singular or plural form according to the specific embodiment proposed herein. However, the singular or plural expression is selected properly for a situation proposed for the convenience of explanation, and thus the various embodiments of the disclosure are not limited to a single or a plurality of components. Therefore, a component expressed in a plural form may also be expressed in a singular form, or vice versa.

While the disclosure has been shown and described with reference to certain preferred embodiments thereof, it will be understood by those skilled in the art that various changes in form and details may be made therein without departing from the spirit and scope of the disclosure as defined by the appended claims. Therefore, the scope of the disclosure is defined not by the detailed description thereof but by the appended claims, and all differences within equivalents of the scope will be construed as being included in the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A user equipment (UE) in a wireless communication system, the UE comprising:
a transceiver; and
a controller coupled with the transceiver, the controller configured to:
receive, from a base station (BS), configuration information on a wake-up signal (WUS);
receive, from the BS, by a wake-up receiver (WUR) of the UE, the WUS, wherein the WUS includes information on a wake-up;
trigger an activation or a deactivation of a main radio of the UE based on the information on the wake-up; and
in case that the activation of the main radio is triggered, receive, by the main radio, a downlink signal from the BS.

2. The UE of claim 1,
wherein the information on the wake-up includes information indicating the deactivation of the main radio.

3. The UE of claim 1,
wherein the information on the wake-up includes information on a specific condition for deactivating the main radio, and
wherein the specific condition is associated with a signal detection of the main radio.

4. The UE of claim 1,
wherein the information on the wake-up includes information for deactivating the main radio after receiving the downlink signal.

5. The UE of claim 1, wherein the controller is further configured to:
transmit, to the BS, capability information on a WUS reception of the UE,
receive, from the BS, configuration information on a connected mode discontinuous reception (C-DRX) or an idle mode DRX (I-DRX), and
in case that the activation of the main radio corresponding to a DRX cycle is triggered based on the configuration information on the C-DRX or the I-DRX and the information on the wake-up, receive, by the main radio, the downlink signal from the BS.

6. Abase station (BS) in a wireless communication system, the BS comprising:
a transceiver; and
a controller coupled with the transceiver, the controller configured to cause the transceiver to:
transmit, to a user equipment (UE), configuration information on a wake-up signal (WUS);
transmit, to a wake-up receiver (WUR) of the UE, the WUS, wherein the WUS includes information on a wake-up; and
in case that an activation of a main radio of the UE is triggered based on the information on the wake-up, transmit, to the main radio, a downlink signal.

7. The BS of claim 6,
wherein the information on the wake-up includes information indicating a deactivation of the main radio.

8. The BS of claim 6,
wherein the information on the wake-up includes information on a specific condition for deactivating the main radio, and
wherein the specific condition is associated with a signal detection of the main radio.

9. The BS of claim 6,
wherein the information on the wake-up includes information for deactivating the main radio after receiving the downlink signal.

10. The BS of claim 6, wherein the controller is further configured to:
receive, from the UE, capability information on a WUS reception of the UE,
transmit, to the UE, configuration information on a connected mode discontinuous reception (C-DRX) or an idle mode DRX (I-DRX), and
in case that the activation of the main radio corresponding to a DRX cycle is triggered based on the configuration information on the C-DRX or the I-DRX and the information on the wake-up, transmit, to the main radio, the downlink signal.

11. A method performed by a user equipment (UE) in a wireless communication system, the method comprising:
receiving, from a base station (BS), configuration information on a wake-up signal (WUS);
receiving, from the BS, by a wake-up receiver (WUR) of the UE, the WUS, wherein the WUS includes information on a wake-up;
triggering an activation or a deactivation of a main radio of the UE based on the information on the wake-up; and
in case that the activation of the main radio is triggered, receiving, by the main radio, a downlink signal from the BS.

12. The method of claim 11,
wherein the information on the wake-up includes information indicating the deactivation of the main radio.

13. The method of claim 11,
wherein the information on the wake-up includes information on a specific condition for deactivating the main radio, and
wherein the specific condition is associated with a signal detection of the main radio.

14. The method of claim 11,
wherein the information on the wake-up includes information for deactivating the main radio after receiving the downlink signal.

15. The method of claim 11, further comprising:
transmitting, to the BS, capability information on a WUS reception of the UE;
receiving, from the BS, configuration information on a connected mode discontinuous reception (C-DRX) or an idle mode DRX (I-DRX); and
in case that the activation of the main radio corresponding to a DRX cycle is triggered based on the configuration information on the C-DRX or the I-DRX and the information on the wake-up, receiving, by the main radio, the downlink signal from the BS.

16. A method performed by a base station (BS) in a wireless communication system, the method comprising:
transmitting, to a user equipment (UE), configuration information on a wake-up signal (WUS);
transmitting, to a wake-up receiver (WUR) of the UE, the WUS, wherein the WUS includes information on a wake-up; and
in case that an activation of a main radio of the UE is triggered based on the information on the wake-up, transmitting, to the main radio, a downlink signal.

17. The method of claim 16,
wherein the information on the wake-up includes information indicating a deactivation of the main radio.

18. The method of claim 16,
wherein the information on the wake-up includes information on a specific condition for deactivating the main radio, and
wherein the specific condition is associated with a signal detection of the main radio.

19. The method of claim 16, wherein the information on the wake-up includes information for deactivating the main radio after receiving the downlink signal.

20. The method of claim 16, further comprising:
receiving, from the UE, capability information on a WUS reception of the UE;
transmitting, to the UE, configuration information on a connected mode discontinuous reception (C-DRX) or an idle mode DRX (I-DRX); and
in case that the activation of the main radio corresponding to a DRX cycle is triggered based on the configuration information on the C-DRX or the I-DRX and the information on the wake-up, transmitting, to the main radio, the downlink signal.
